(19) United States
(12) Patent Application Publication
(10) Pub. No.: US 2011/0145757 A1
(43) Pub. Date: Jun. 16, 2011

(54) Scrolling Control and Communication Control Applications and Methods

(76) Inventor: Fida Janwari, Phoenix, AZ (US)

(21) Appl. No.: 12/958,299

(22) Filed: Dec. 1, 2010

Related U.S. Application Data
(60) Provisional application No. 61/265,616, filed on Dec. 1, 2009.
(60) Provisional application No. 61/265,618, filed on Dec. 1, 2009.

(51) Int. Cl. G06F 3/048

(52) U.S. Cl. 715/786; 715/802

(57) ABSTRACT

Embodiments of the invention provide a system including at least one computing device with a processing unit configured to display a graphical user interface and execute a scrolling control application and a communication control application. The scrolling control application is executed to provide a first frame including interactive content and a second frame including interactive content through the graphical user interface. User interaction with the interactive content is limited to only the frame in a specific frame display position. The communication control application is executed to provide a communication window through the graphical user interface despite navigation from a first web page to a second web page.

### RELATED APPLICATIONS

This application claims priority under 35 U.S.C. §119 to U.S. Provisional Patent Application Nos. 61/265,616 and 61/265,618 filed on Dec. 1, 2009, the entire contents of which are incorporated herein by reference.

### BACKGROUND

Conventional web sites require multiple browsers to be opened or multiple web pages to be navigated through in order to view different interactive media content, such as videos. Management of multiple browsers and retracing through multiple web pages can be difficult and often time-consuming for users. In addition, communication between two or more users can be achieved through conventional “chat” programs. These chat programs are often separate from web sites and therefore are opened in separate browsers or application windows. As a result, users must toggle between different browsers or windows in order to continue communication and viewing of web sites.

### SUMMARY

Some embodiments of the invention provide a system including at least one computing device. The computing device can include a processing unit configured to provide a graphical user interface displayable at a user computer. The graphical user interface includes a first page with at least a first frame including interactive content and a second frame including interactive content. The processing unit is also configured to determine which of the first frame and the second frame is currently selected. Upon selection of the first frame, the processing unit is configured to display substantially an entire portion of the first frame on the first page, enable the interactive content on the first frame, display at least a portion of the second frame on the first page, and disable the interactive content on the second frame. Upon selection of the second frame, the processing unit is configured to display substantially an entire portion of the second frame on the first page, enable the interactive content on the second frame, display at least a portion of the first frame on the first page, and disable the interactive content on the first frame.

Some embodiments of the invention provide a computer-implemented method of electronically scrolling through interactive frames. The method includes selecting, using a computing device, data for a plurality of frames from a database, creating the plurality of frames based on the data, where each of the plurality of frames includes interactive content, and assigning an order of the plurality of frames. The method also includes initiating, using the computing device, display of substantially an entire portion of one frame from the plurality of frames in a first frame display position on a page based on the order, where the page is displayable to a user on a user computing device and initiating display of at least a portion of a next consecutive frame from the plurality of frames in a second frame display position on the page based on the order. Upon detection of a scrolling action by the user from the user computing device, the method includes initiating, using the computing device, display of substantially an entire portion of the next consecutive frame from the plurality of frames in the first frame display position on the page, initiating display of at least a portion of a second next consecutive frame from the plurality of frames in the second frame display position on the page based on the order. The method further includes limiting user interaction with the interactive content to only the frame in the first frame display position.

Some embodiments of the invention provide a system including at least one computing device. The computing device can include a processing unit configured to provide a first graphical user interface displayable at a first user computer, where the first graphical user interface displays a first page, and initiate a communication between the first user computer and a second user computer through a first communication window displayed over the first page in the first graphical user interface. The processing unit is also configured to determine if the first communication window has been disrupted due to one of navigation from the first page to a second page on the first graphical user interface and completion of the communication. If the first communication window has been disrupted due to navigation from the first page to a second page, the processing unit is configured to display the first communication window over the second page and retrieve communication data from a database. If the first communication window has been disrupted due to completion of the communication, the processing unit is configured to provide an indication to one of the first user computer and the second user computer that the communication has ended.

### DESCRIPTION OF THE DRAWINGS

FIG. 1 is a perspective view of a system for use in implementing a scrolling control application according to one embodiment of the invention.

FIG. 2 is a screen shot of a main web page of a web site incorporating the scrolling control application according to one embodiment of the invention.

FIG. 3 is a screen shot of a main web page of a web site incorporating the scrolling control application according to another embodiment of the invention.

FIG. 4 is a screen shot of a user profile web page of the web site incorporating the scrolling control application.

FIG. 5 is a screen shot of a poll results web page of the web site incorporating the scrolling control application.

FIG. 6 is a flow chart illustrating a method of the scrolling control application for filtering polls.

FIG. 7 is a flow chart illustrating a poll frame display method of the scrolling control application.

FIG. 8 is a flow chart illustrating a scrolling control method of the scrolling control application.

FIG. 9 is a screen shot of a poll creation web page of the scrolling control application.

FIG. 10 is a class diagram layout of the scrolling control application.

FIG. 11 is a layout of one class within the class diagram layout of the scrolling control application.

FIG. 12 is a perspective view of a system for use in implementing a communication control application according to one embodiment of the invention.

FIG. 13 is a screen shot of a web page of a web site incorporating the communication control application according to one embodiment of the invention.

FIG. 14 is a screen shot of a web page of the web site incorporating the communication control application according to another embodiment of the invention.

FIG. 15 is another screen shot of the web page of FIG. 13.

FIG. 16 is another screen shot of the web page of FIG. 14.

FIG. 17 is another screen shot of the web page of FIG. 13.

FIG. 18 is another screen shot of the web page of FIG. 14.

FIG. 19 is another screen shot of the web page of FIG. 13.

FIG. 20 is another screen shot of the web page of FIG. 13.

FIG. 21 is a flow chart illustrating methods of the communication control application.

FIG. 22 is another flow chart illustrating methods of the communication control application.

FIG. 23 is another flow chart illustrating methods of the communication control application.

FIG. 24 is a flow diagram of processes of the scrolling control application according to one embodiment of the invention.

FIG. 25 is a flow diagram of objects and functions of the scrolling control application which can be used to load interactive media content, such as articles, videos, and images, on a web page.

FIG. 26 is a flow diagram of processes of the scrolling control application, according to one embodiment of the invention, for uploading interactive media content on a web site.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The computer program instructions described in this disclosure can be provided to a processor of a special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes, without limitation, volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

In general, some embodiments of the invention provide a web-based scrolling control application. The scrolling control application can allow users to scroll through numerous frames of multimedia in a single web page. In some embodiments, the multimedia can include polls, reviews, and/or statistics. The multimedia can be uploaded by users or a system administrator to a common server and can include interactive media content such in the form of virtual buttons, hyperlinks, images, articles, audio and/or video. The scrolling control application can include one or more customized multimedia players that can display multimedia files of different file types. The scrolling control application can also be used to share the multimedia with other websites (e.g., websites that are not specifically controlled by the scrolling control application).

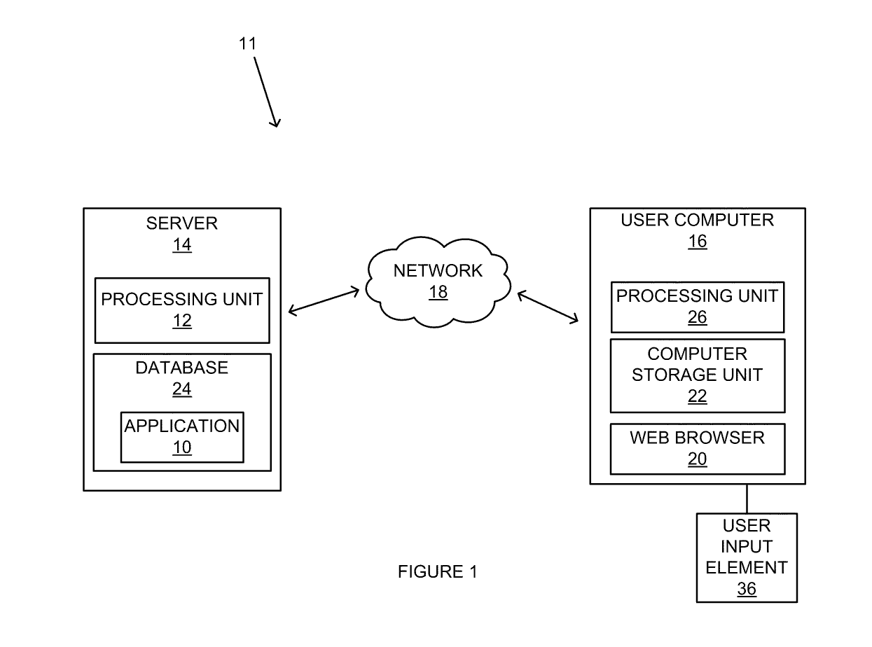

In some embodiments of the invention, the scrolling control application 10 can be implemented through a system 11, as shown in FIG. 1. More specifically, the application 10 can include computer program code and instructions, as described above, that are executable by a processing unit 12 of a server 14 and can be accessed by a user via a user computer 16, as shown in FIG. 1. The user computer 16 can be in communication with the server 14 via a network 18, such as the Internet, to receive and transmit information through web pages of a web site controlled by the processing unit 12 of the server 14. For example, the application 10 can be incorporated into web pages of the web site and the web pages can provide a graphical user interface (e.g., viewable through a web browser 22 of the user computer 16) for the user to interact with the application 10. The information received and transmitted through the web pages, as further described below, can be stored on a computer-readable medium of the user computer 16 (e.g., a computer storage unit 22) and/or on a computer-readable medium of the server 14 (e.g., a server database 24).

In one embodiment, the entire application 10 or a portion of the application 10 can be stored on the server 14 and can be accessed by the user computer 16 when the server 14 and the user computer 16 are connected via the common network 18. In addition, some instructions of the application 10 can be executed by a processing unit 24 of the user computer 16. In some embodiments, the application 10 can provide additional user interaction through the web site when the user has provided log-in credentials to the web site which match credentials stored on the server database 24 (i.e., when the user has “logged in” to the web site).

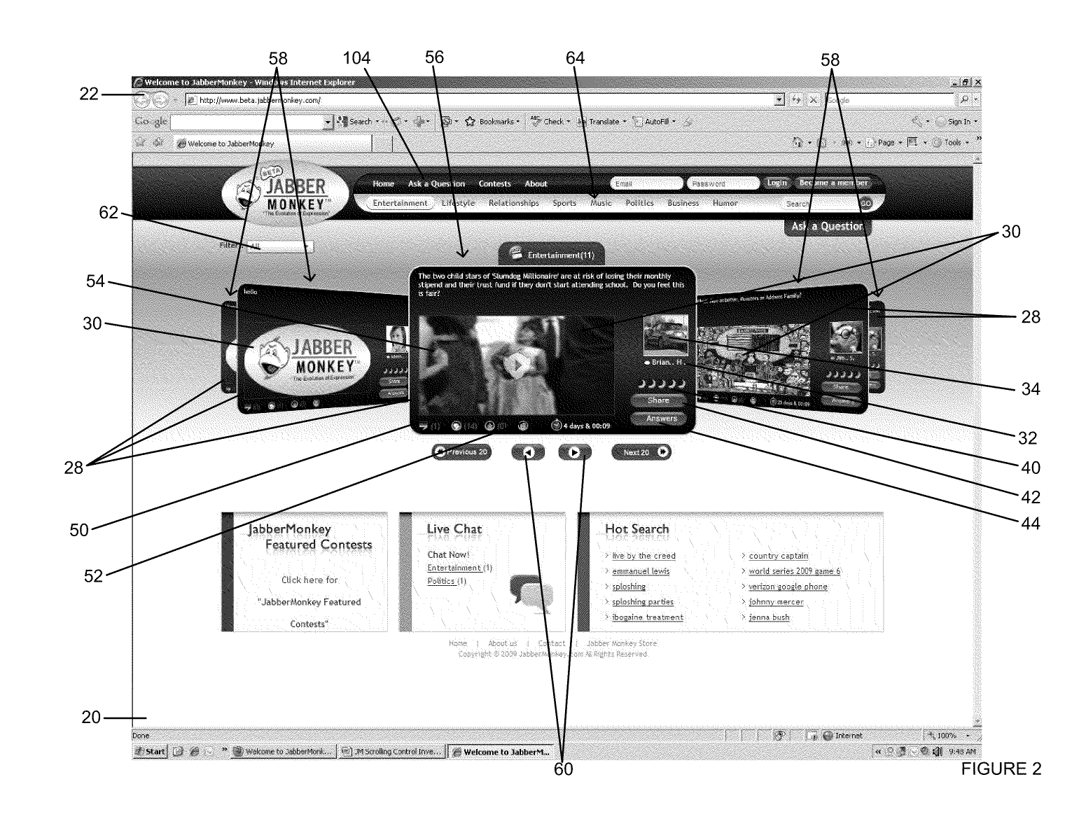

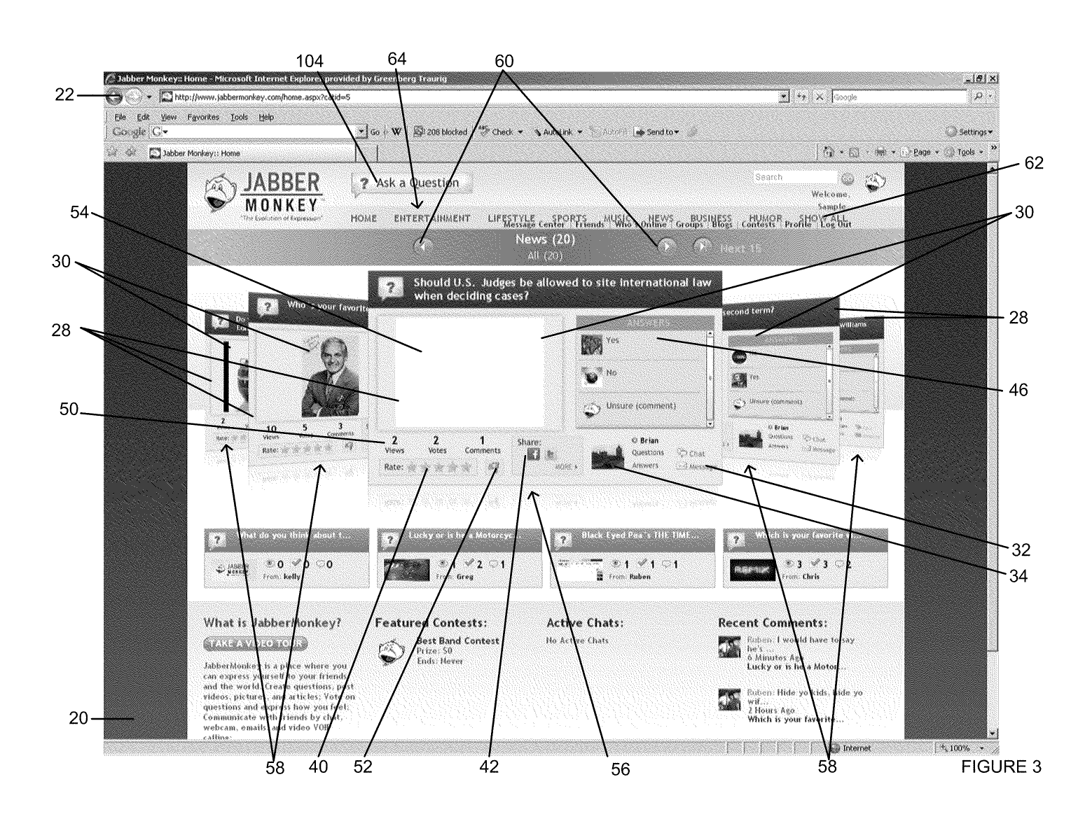

FIG. 2 illustrates a main web page 20 incorporating the application 10, according to one embodiment of the invention, as part of a graphical user interface. FIG. 3 illustrates the main web page 20 incorporating the application 10, according to another embodiment of the invention, as part of a graphical user interface. For example, as shown in FIGS. 2 and 3, the application 10 can be executed to display poll frames 28, each corresponding to a specific poll, on a web page 20. Each poll frame 28 can include static and/or dynamic interactive media content 30 such as selective virtual buttons, hyperlinks, dropdown menus, images, articles, video and/or audio content, and/or scroll bars in order to illustrate polls, poll timers, a user profile, rankings, sharing options, results, video and/or audio, comments, views, votes, and/or reports for inappropriate content. A user can access the main web page 20 and interact with the interactive media content 30 of the application 10 through the web browser 22 of the user computer 16 (i.e., in communication with the network 18).

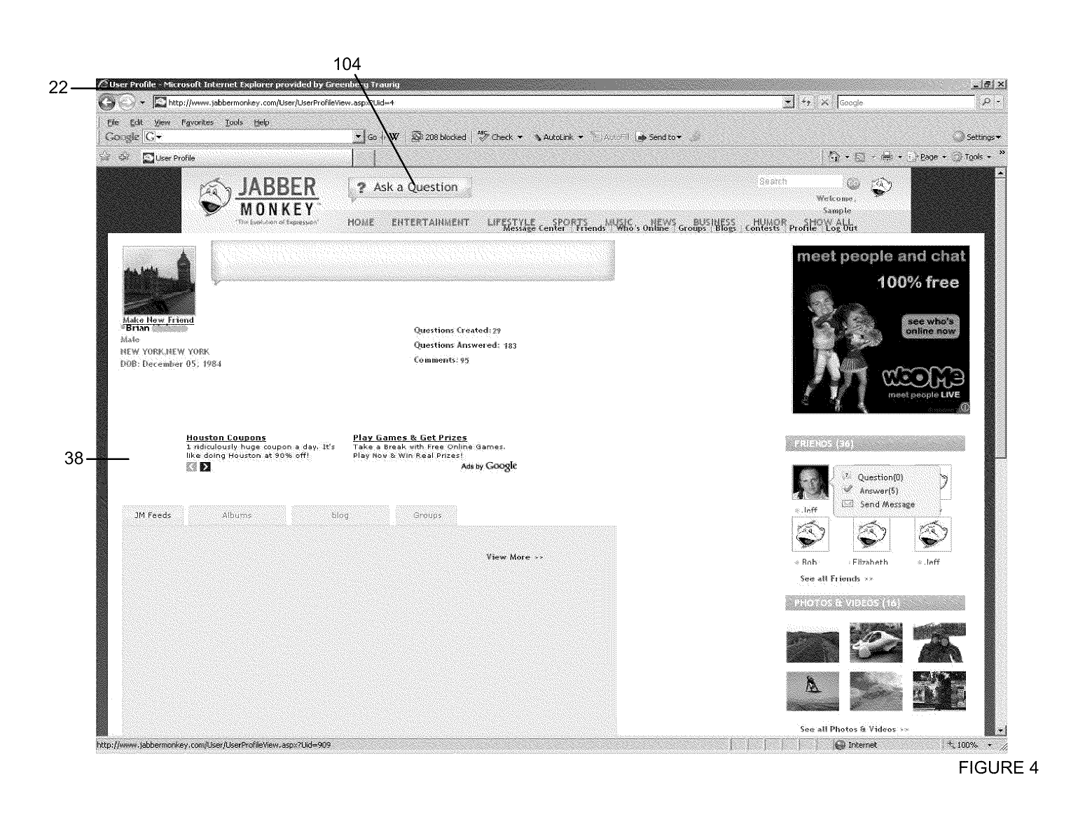

In one embodiment, as shown in FIGS. 2 and 3, the poll frames 28 can be displayed near the center of the main web page 20. The application 10 can display multiple poll frames 28 at a time on the main web page 20 and each poll frame 28 can include poll descriptions displayed with associated interactive media content 30. Polls created with an end date, as described below, can be displayed with a timer showing the remaining time before the poll expires. In one embodiment, for example near the right side of each poll frame 28, a user profile 32 can be displayed corresponding to the poll's creator. The poll creator's profile picture 34 can be displayed with the poll creator's name, and by clicking on the profile picture 34 (i.e., by a user selecting the profile picture 34 using an input element 36 of the user computer 16), the application 10 can redirect to a separate web page of the web site which represents the poll creator's user profile page 38, as shown in FIG. 4. In some embodiments, on mouse-over of the profile picture 34, information about the poll creator can be displayed (e.g., in a pop-up window over the web page 20), such as the amount of polls they have created, or an amount of answers or comments submitted to other polls. In addition, on mouse-over of the poll creator's profile picture 34, the user can be given the option to request the poll creator as an online “friend”. Also, if the poll creator is already a friend of the user, then the user can have the option to send an internal message or, if the poll creator is online and logged into the web site, chat with the poll creator, as described below.

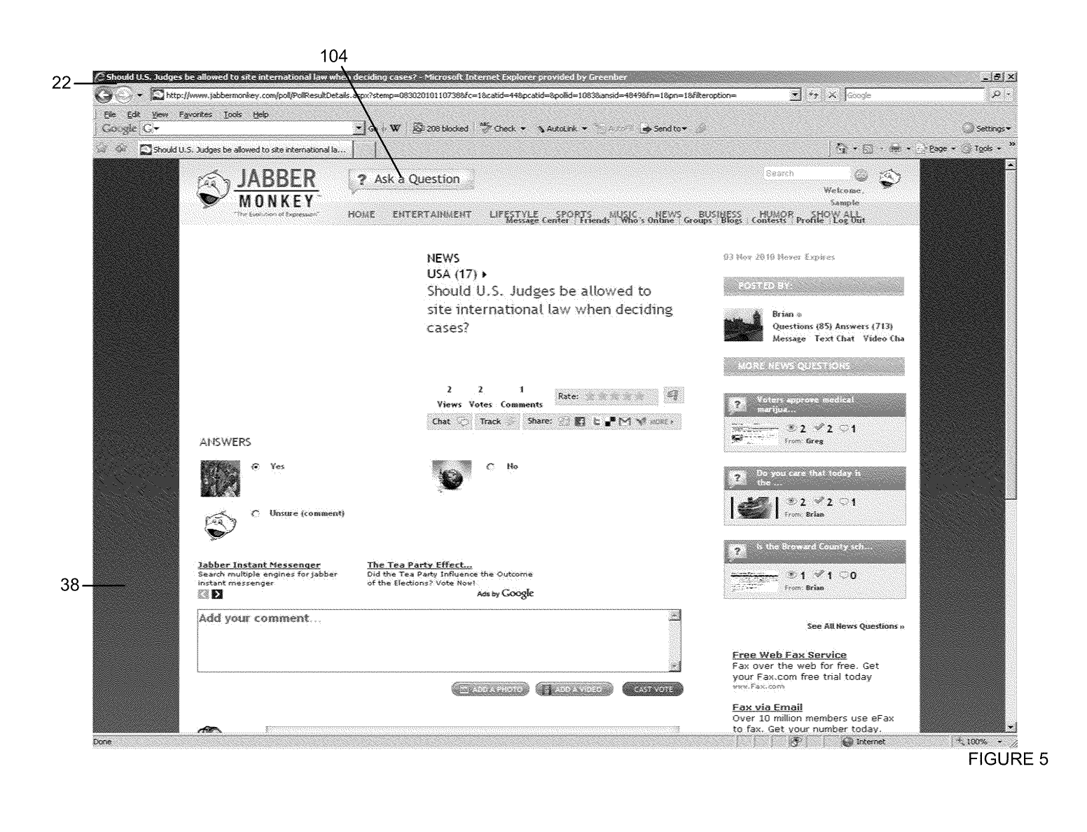

As shown in FIGS. 2 and 3, each poll frame 28 can display an overall ranking 40 of the corresponding poll, as rated by the user and other users, for example between 1 and 5. Sharing options 42 can also be displayed on each poll frame, allowing the user to share polls on other websites such as Facebook®, Google®, Twitter®, Digg®, Stumbleupon®, etc. In addition, each poll frame 28 can include a results/answers button 44, as shown in FIG. 2, or a results/answers section 46, as shown in FIG. 3. By clicking on or selecting the results button 44 or the results section 46, the user can cast a vote for the poll (e.g., on a separate results web page 48, as shown in FIG. 5) and, in some embodiments, view results of the poll. In one embodiment, on mouse-over of the results button 44, the results section 46 can be displayed over the web page 20 including poll answers and/or other media. The user can select an option from the results section 46, which can cause the application 10 to direct the user to the results web page 48. In addition, for example near the bottom of the poll frames 28, a section 50 for comments, views, and/or voting information can be displayed, as well as an option 52 for the user to report any inappropriate content.

Some or all poll frames 28 can include a visual media section 54, as shown in FIGS. 2 and 3. The visual media section 54 can show a media thumbnail related ,to the poll. When the user clicks on or selects the visual media section 54, different actions can occur according to the type of visual media in the visual media section 54. For example, if the visual media type is a video, clicking on the frame can play the video (e.g., within the visual media section or in a pop-up window). If the visual media type is a picture, clicking on the visual media section can open the picture (e.g., in a pop-up window). If the visual media type is an article, clicking on the visual media section can open the article (e.g., in a pop-up window).

The application 10 can include customized multimedia players in order to display videos within the visual media section 54 supported by, for example, Microsoft Silverlight® as well as other media types such as flash video files. For example, in some embodiments, the application 10 can support “.wmv” video files (i.e., through, Microsoft Silverlight®), as well as other media files such as “.flv”, “.mp4”, “.mpeg”, among others. The application 10 can also include instructions to play shared resources from different sites. For example, videos from a website such as www.youtube.com can be displayed using a combination of JavaScript®, flash objects, html and Microsoft Silverlight®. Microsoft Silverlight® can communicate with a flash object through a JavaScript® method by passing appropriate information to call for the video from the other web site and play the video. The JavaScript® method can then initialize the flash object and render it back into html. Once the video ends, a video close message through JavaScript® can be sent to close the video player. The following code is an example of the above video display method according to one embodiment of the invention:

### Silverlight®:

1) void OpenPollVideo(object sender, MouseEventArgs e)
   This function invoke the javascript openVideo function to play the video file. This function passes the Poll file path, Poll mediaid, userID and PollID as parameters.

### Javascript® Methods:

1) function openVideo(sFilePath, iPollMediaId, iUserId, iPollId, ServerUrl)
   Initialize the flash object and renders into the html div control.
2) function closeVideo(param)
   Closes the running video player.

As shown in FIGS. 2 and 3, the application 10 can provide a graphical representation of the polls in a scrollable fashion. Through the application 10, the server database 24 can store an endless number of polls, and, in some embodiments, the application 10 can display three or five poll frames 28 on the web page 20 at one time: a central poll frame 28 at a central poll frame location 56, and two or four peripheral poll frames 28 at peripheral poll frame locations 58, such as one or two poll frames 28 to the left of the central poll frame location 56, and one or two poll frames 28 to the right of the central poll frame location 56. In addition, in some embodiments, the application 10 can provide a single main web page 20 with up to fifteen or twenty poll frames 28 (e.g., where three to five poll frames 28 are visible at a time, and the other poll frames 28 are temporarily hidden). The user can scroll between the twenty poll frames 28 per web page 20 by clicking on or selecting directional buttons 60 on the web page 20, as shown in FIGS. 2 and 3, or by clicking on specific peripheral poll frames 28.

In some embodiments, the peripheral poll frames 28 can be only partially visible, slightly smaller, and/or grayed out compared to the substantially fully visible central poll frame 28, and the application 10 can only allow the user to interact with the interactive media content 30 of the poll frame 28 in the central poll frame location 56 (i.e., only the media content of the central poll frame 28 is enabled, while media content of the peripheral frames 28 and hidden poll frames 28 is disabled). In one example, if there are three poll frames 28 visible at a time, when the user selects the poll frame 28 in the left peripheral location 58, the old central poll frame 28 moves to the right peripheral location 58 (i.e., becoming the new right poll frame 28), the old left poll frame 28 moves to the central poll frame location 56 (i.e., becoming the new central poll frame 28), the old right poll frame 28 is hidden, and a previously hidden poll frame 28 moves to the left peripheral location 58, becoming the new left poll frame 28. The interactive media content 30 of the new central poll frame 28 can be enabled for user interaction, while the interactive media content 30 of the peripheral poll frames 28 can be substantially viewable, but disabled. More specifically, the application 10 can determine which of the poll frames 28 is selected as the central poll frame 28 and then display substantially an entire portion of the central poll frame 28 and enable the interactive media content 30 of the central poll frame 28. The application 10 can also display at least a portion of the peripheral poll frames 28 and disable the media content 30 of the peripheral poll frames 28. In some embodiments, when the web page 20 is loaded onto the user computer 16, a default central poll frame 28 can be displayed.

In some embodiments, the application 10 can provide a selection option 62 to filter the polls that are viewed, such as by their functionality. For example, filtering categories can include action polls (e.g., polls which have an end date associated with them), “NSFW” polls (e.g., polls that are not safe for a work environment), contest polls (e.g., polls created for contest purposes, such as by the web site administrator), normal polls (e.g., polls which do not fall under the other categories listed above), etc. In addition, a selection option, such as subject headers 64, can be provided to filter the polls that are viewed by their subject. For example, the application 10 can display the subject headers 64 which, when selected by the user, can cause the application 10 to filter the poll frames 28 displayed by the subjects of their corresponding polls, such as sports polls, entertainment polls, lifestyle polls, music polls, news polls, business polls, humor polls, etc.

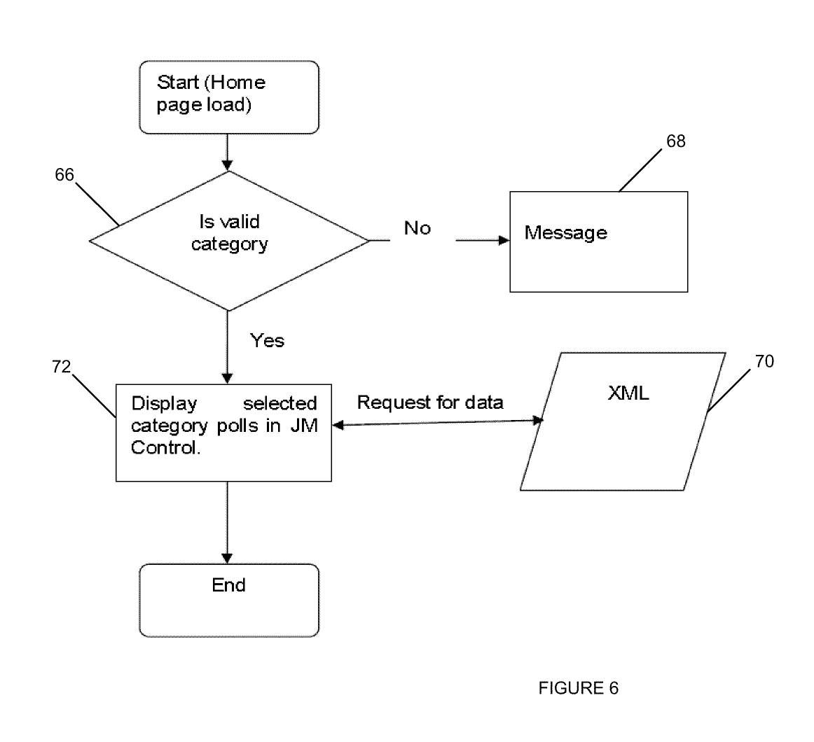

In some embodiments, poll data for each poll can be stored in the server database 24. The stored poll data can include data relating to specific functionality, subject, privacy, start and end dates, and/or other categories. When the web page 20 is loaded within the web browser 22 of the user computer 16, the processing unit 12 of the server 14 can select twenty polls within the database 24, create poll frames 28 associated with the polls, and display the poll frames 28 on the web page 20. In some embodiments, the polls originally selected by the processing unit 12 when the web page 20 is first loaded within the web browser 22 can be substantially random with regards to functionality and subjects. The application 10 can include the selection option 62 on the web page 20 for the user to filter the polls by the above-mentioned functionality categories, or the subject headers 64 to filter the polls by the above-mentioned subjects. As shown in the flowchart of FIG. 6, after the web page 20 has been loaded, the application 10 can determine if the user has chosen as valid filtering category, at step 66. If not, an error message can be displayed at step 68. If the user has chosen a valid filtering category (for example using the selection options 62 or 64) the application 10 can retrieve a number of polls (e.g., twenty) associated with the selected functionality or subject from the server database 24 (i.e., by sending requests for poll data from the sever database 24), at step 70, and the poll frames 28 can then be created using the data and displayed on the web page 20, at step 72.

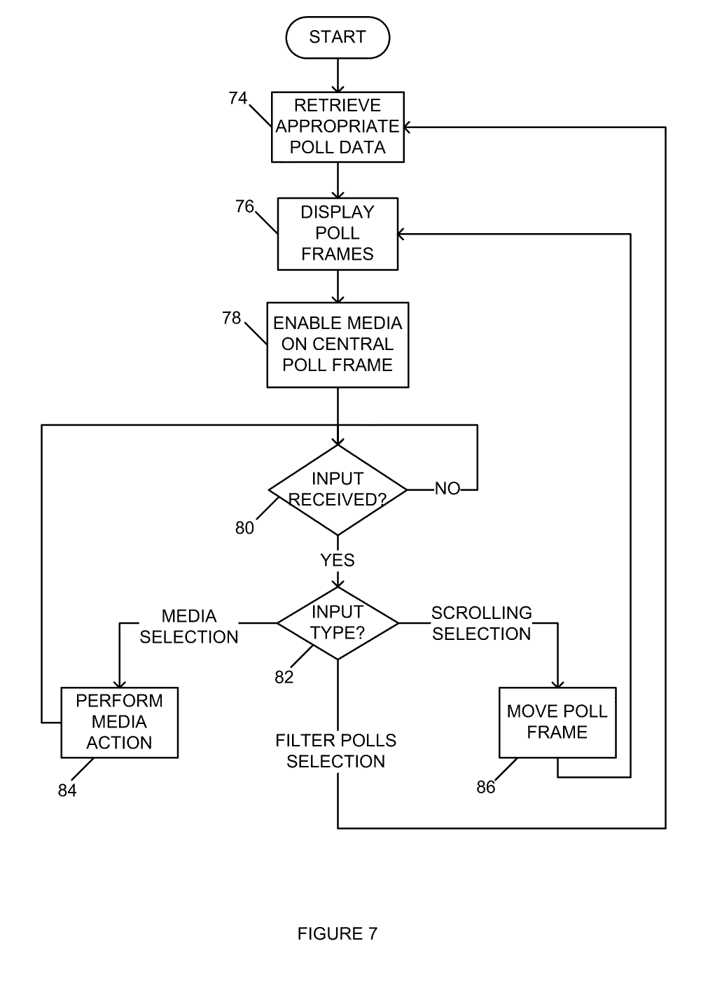

FIG. 7 is a flow chart illustrating some actions of the application 10. At step 74, the application 10 can retrieve poll data, for example from the sever database 24. At step 76, poll frames 28 corresponding to the retrieved poll data can be displayed to the user, including a central poll frame 28, peripheral poll frames 28, and hidden poll frames 28. At step 78, interactive media content 30 of the central poll frame 28 can be enabled (e.g., while interactive media content 30 of the peripheral poll frames 28 and hidden poll frames 28 is disabled). At step 80, the application 10 can determine if user input has been received, for example from the input element 36 in communication with the user computer 16, such as a mouse, keyboard, touchpad, etc. If user input has been received, the application 10 can determine the input type at step 82. If the input type is selection of the interactive media content 30, the application 10 can execute a media action at step 84, then return to step 80 to wait for user input. If the input type is selection of a filtering functionality or category, the application 10 can return to step 76 to retrieve appropriate poll data corresponding to the specific functionality or category. If the input type is a scrolling selection, either by selection of a specific peripheral poll frame 28 or selection of virtual directional buttons 60 on the web page 20, the application 10 can initiate movement of the poll frames 28 at step 86, as described below, and return to step 78 to display the appropriate poll frames 28.

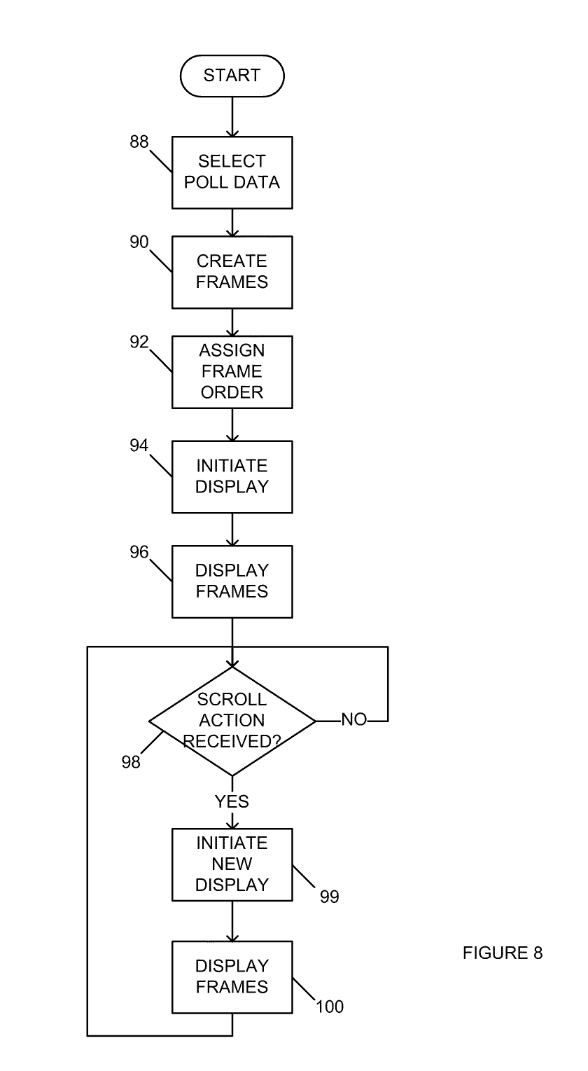

FIG. 8 is a flow chart illustrating the scrolling action of the application 10 according to one embodiment of the invention. At step 88, the application 10 can select data for an amount of polls from the sever database 24. In some embodiments, the amount of polls can be about fifteen or twenty. At step 90, the application 10 can create a poll frame 28 for each poll using the poll data. At step 92, the application 10 can assign an order of the poll frames 28 (for example, poll frame #1, poll frame #2, poll frame #3 . . . poll frame #20). At step 94, the application 10 initiate display of the poll frames 28, including determining which poll frame 28 in the order is the central poll frame 28, enabling the interactive media content 30 on the selected central poll frame 28, determining the peripheral poll frames 28 which will be at least partially displayed, and determining the hidden poll frames 28. For example, if poll frame #3 is selected as a default central poll frame 28 when the web page 20 is initially loaded, the application 10 can enable the interactive media content 30 of poll frame #3 and initiate display of poll frame #3 in the central frame location 56. The application 10 can also initiate display of poll frame #1 and poll frame #2 in the peripheral frame locations 58 to the left of the central frame location 56 and initiate display of poll frame #4 and poll frame #5 in the peripheral frame locations 58 to the right of the central frame location 56, while disabling the interactive media content 30 of poll frames #1, #2, #4, and #5. The application 10 can further initiate poll frames #6-#20 to be hidden with their interactive media content 30 disabled. At step 96, the appropriate poll frames 28 can be displayed, as determined in step 94, where user interaction with the interaction media content 30 of the poll frames 28 is limited to only the poll frame 28 in the central frame location 56.

Upon a scrolling action by the user, as determined at step 98, the application 10 can initiate a new display of the poll frames 28 at step 99, including determining which poll frame 28 in the order is the central poll frame 28, enabling the interactive media content 30 on the selected central poll frame 28, determining the peripheral poll frames 28 which will be at least partially displayed, and determining the hidden poll frames 28. For example, if poll frame #3 is at the central frame location 56 and the user chooses to move the poll frames 28 to the right by selecting the right directional button 60 on the web page 20, the application 10 can enable the interactive media content 30 of poll frame #2 and initiate display of poll frame #2 in the central frame location 56. The application 10 can also initiate display of poll frame #20 and poll frame #1 in the peripheral frame locations 58 to the left of the central frame location 56 and initiate display of poll frame #3 and poll frame #4 in the peripheral frame locations 58 to the right of the central frame location 56, while disabling the interactive media content of poll frames #20, #1, #3, and #4. The application 10 can further initiate poll frames #5-#19 to be hidden with their interactive media content 30 disabled.

In another example, if poll frame #3 is at the central frame location 56 and the user selects poll frame #5 (i.e., in the peripheral location 58), the application 10 can enable the interactive media content 30 of poll frame #5 and initiate display of poll frame #5 in the central frame location 56. The application 10 can also initiate display of poll frame #3 and poll frame #4 in the peripheral frame locations 58 to the left of the central frame location 56 and initiate display of poll frame #6 and poll frame #7 in the peripheral frame locations 58 to the right of the central frame location 56, while disabling the interactive media content 30 of poll frames #3, #4, #6, and #7. The application 10 can further initiate poll frames #1-#2 and #8-#20 with their interactive media content 30 disabled. At step 100, the appropriate poll frames 28 can be displayed, as determined in step 99, where user interaction with the interactive media content 30 of the poll frames 28 is limited to only the poll frame 28 in the central frame location 56.

As described above, the order assigned to the poll frames 28 can be continuous, wherein the last poll frame 28 in the order (e.g., poll frame #20 in the example above) can be followed by the first poll frame 28 in the order (e.g., poll frame #1 in the example above). As a result, the poll frames 28 can be continuously scrolled to the left or to the right without reaching a stopping point. In addition, the application 10 can increment a frame-specific counter each time a poll frame 28 is displayed at the central poll frame location 56. The counter can be stored in the sever database 24 as poll data. The counter can also be displayed on the poll frame 28 as the number of views the poll frame 28 has received (e.g., in the comments/views/voting information section 50). Other poll-specific data based on user interactions with the poll frames 28 can also be stored in the sever database 24, such as results selected, comments submitted, etc.

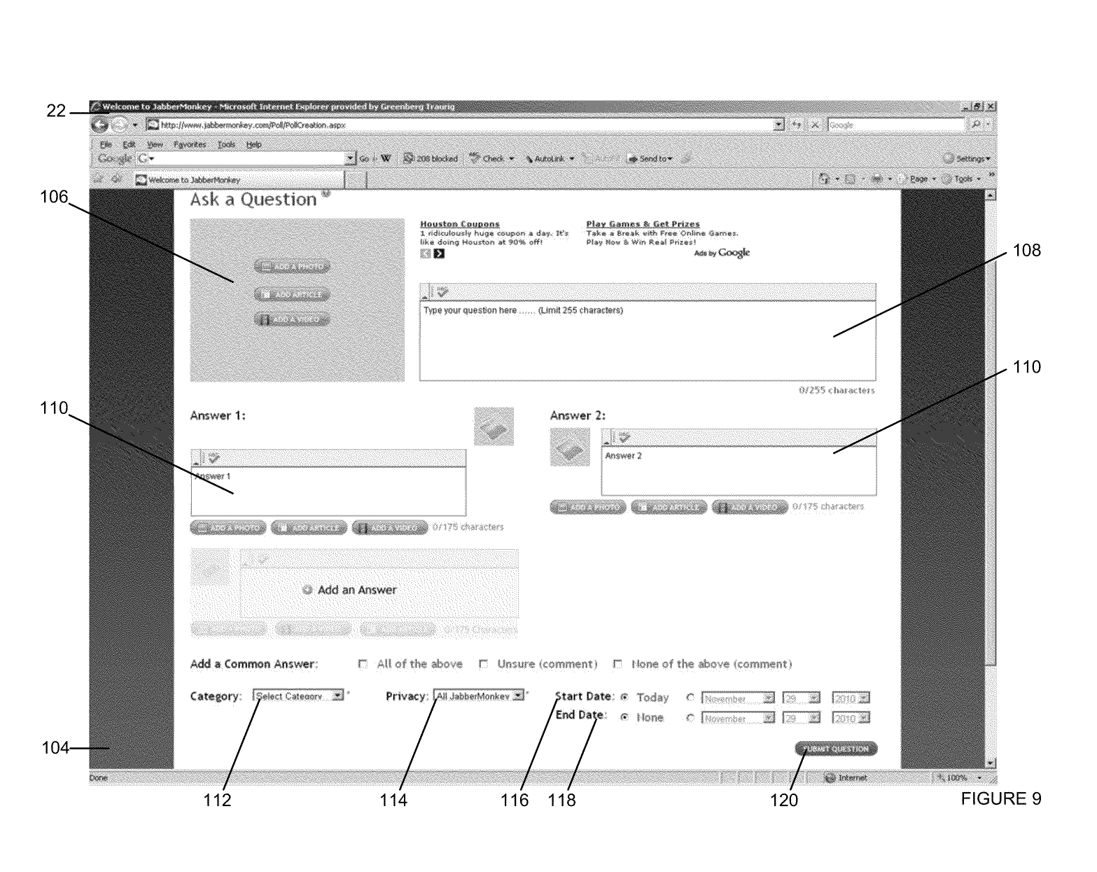

In addition, users can submit polls to be created by, the application 10. For example, the user can select a poll submission button 102 on the web page 20 as shown in FIG. 3. The user can then be redirected to a poll creation web page 104, as shown in FIG. 9. As shown in FIG. 9, in a media input section 106, the user can provide a photo, a video, or an article to be displayed in the visual media section 54 of the poll frame 28. The photo or the video can be uploaded from the user computer 16 or can be connected to a separate website through a hyperlink URL, as described below. The article can also be connected to a separate website through a hyperlink URL, as described below. In a question section 108, the user can type in the poll question. The user can also provide possible answers in answer sections 110. Each of the answer sections 110 can also optionally include an uploaded or linked video, article, or photo. In addition, the user can select a subject from a category dropdown menu 112, select which users can view the poll frame through a privacy dropdown menu 114, and select a start date 116 and/or an end date 118 for the poll. The user can then submit the poll via a submit question button 120 on the poll creation web page 104.

All of the data added through the poll creation web page 104 can be submitted to the server 14 and stored in the sever database 24 as a new poll. The processing unit 12 can then retrieve the new poll data to create a poll frame 28 and display the poll frame 28 when appropriate, as described above. If the poll data includes an expiration date input by the user, the poll data can be removed from or substantially hidden within the sever database 24 after the poll has expired. In addition, if the poll data includes a privacy setting that is not public, the poll frame 28 may only be displayed for appropriate users.

In some embodiments, the application 10 can be incorporated into other web-based applications, web sites, or stand-alone computing devices (e.g., single computing devices including the elements of the server 14 and the user computer 16) for scrolling other types of multimedia. In some embodiments, the computer program code and instructions of the application 10 can be developed using a combination of one or more of the following: Microsoft® Silverlight®, Microsoft® Visual Studio® .Net, Asp.Net, Visual C++®, Visual C#® .Net, AJAX, XML, Adobe Flash®, HTML, ActionScript®, JavaScript®, VBScript, and other programming languages and tools. For example, Microsoft Silverlight® Expression Blend can be used to develop the application 10, or graphical user interface, displayed on the web page 20. All event handing can be performed with C#® and communication through the web page 20 from the user side can be performed with JavaScript®. The application 10 can be developed to operate in Windows®, Mac®, or other Operating System-based web browsers such as Internet Explorer®, Mozilla® Firefox®, Google Chrome™, Apple® Safari®, Opera®, Netscape Navigator®, etc.

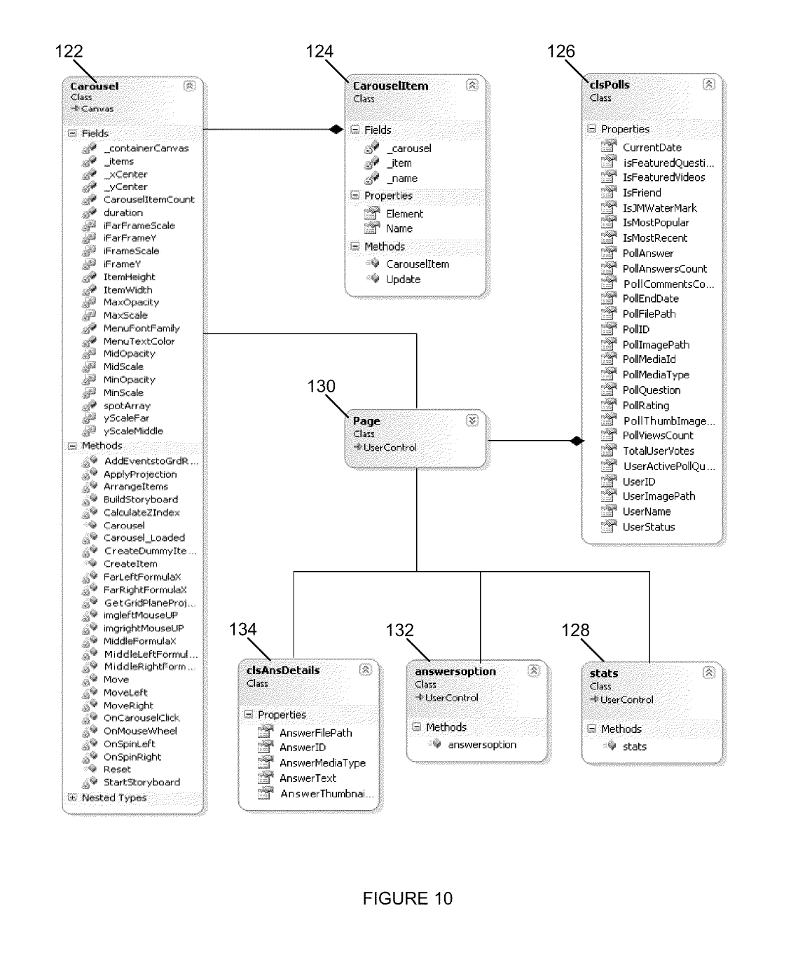

In one embodiment, instructions can be developed for the application 10 including the following classes: “Carousel” class 122, “CarouselItem” class 124, “CIsPolls” class 126, “Stats”class 128, “Page” class 130, “Answeroption” class 132, and “ClasAnsDetails” class 134, as shown in the class diagram layout in FIG. 10. The Carousel class 122 can be the main class for controlling the scrolling effect of the poll' frames and can be the container for all poll frames. The Carousel class 122 can include the following methods in some embodiments:

Carousel_Loaded(object sender, RoutedEventArgs e): Display all poll frame on the screen.

void AddEventstoGrdRemote( ): Add the left and rigt spin(scroll) event for the control.

private Storyboard BuildStoryboard(string name, double tox, double toy, double too, double tos, Duration d): Add animation effects to poll frames.

private void ArrangeItems( ): Arrange the frame items (two left side, one in center, and two right side).

public void CreateItem(FrameworkElement fe, string name): Add poll frame to CarouselItem collection.

private double FarLeftFormulaX( ): Return the value for far left set left frame display position.

private double MiddleLeftFormulaX( ): Return the value for set middle left frame position.

private double MiddleFormulaX( ): Return the value for set middle frame position

private double MiddleRightFormulaX( ): Return the value for set middle right frame position

private double FarRightFormulaX( ): Return the value for set far right frame position

void OnCarouselClick(object sender, MouseButtonEventArgs e): Move left and right side frame in appropriate position when user click on the frame.

void OnSpinLeft(object sender, MouseButtonEventArgs e): Call moveLeft left function.

void OnSpinRight(object sender, MouseButtonEventArgs e): call moveRight right function.

void MoveRight(int numOfSpots): call move function with supply parameters.

void MoveLeft(int numOfSpots): call move fuction with supply parameters

void Move(Direction d, int numOfSpots): Move frame in appropriate direction.

void ApplyProjection(int itemIndex, int X, int Y, int Z): Set the projection (tilled effects) for frames using GetGridPlaneProjects function.

private PlaneProjection GetGridPlaneProjects(double RotationX, double RotationY, double RotationZ): Set the x,y,x coordinate to frame for set projection.

The CarouselItem class 124 can control the addition and display of new poll frames 28. The CarouselItem class 124 can include the following method in some embodiments:

public void Update(double left, double top, int zIndex, double scale, double opacity): Set the left, top and z-index and opacity for frame.

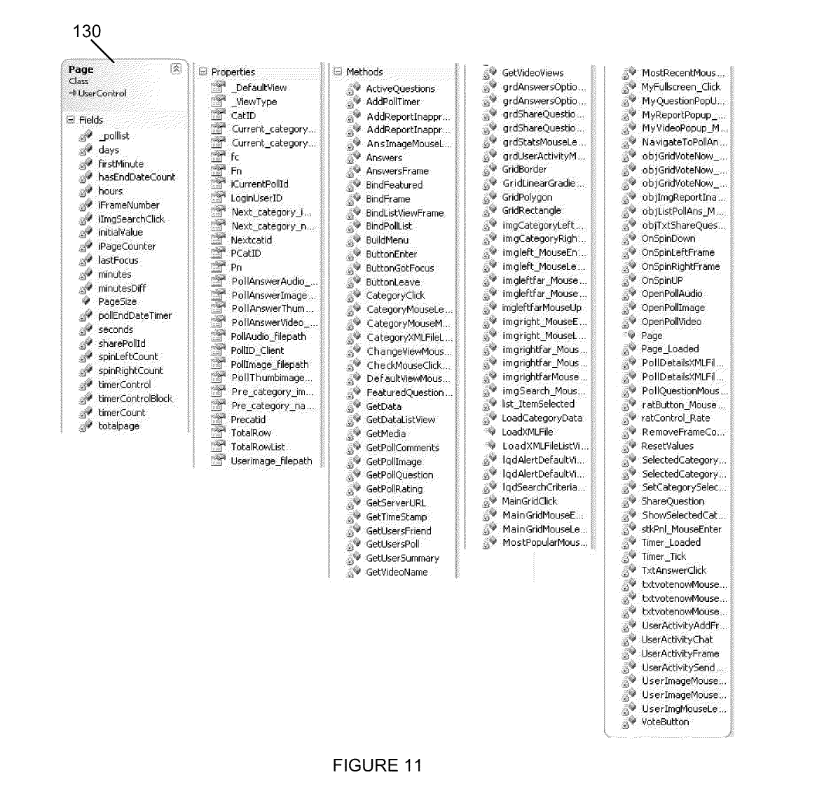

The ClsPolls 126 class can include poll frame field properties of the poll frames 28 and can be part of the Page class 130. The Stats class 128 can include user stats. The Page class 130 can control poll frame layouts and event handling due to user interaction. The Page class 130, as shown in more detail in FIG. 11, can include the following methods in some embodiments:

GetTimeStamp( )return type string: Return unique current month, day, year, hour, minutes, seconds string.

LoadXMLFile(string Path, string Name)( ): Make Asynchronous request for load the selected category poll.

void PollDetailsXMLFileLoaded(object sender, DownloadStringCompletedEventArgs e): This function is invoked when Asynchronous call is completed for selected category.

void OnSpinRightFrame(object sender, MouseButtonEventArgs e): Move Poll frame to right direction

void OnSpinLeftFrame(object sender, MouseButtonEventArgs e): Move poll frame to left direction.

void OpenPollVideo(object sender, MouseEventArgs e): Invoke javascript function to play the video.

void OpenPollImage(object sender, MouseEventArgs e): Invoke javascript function to display the image

private void objGridVoteNow_MouseEnter(object sender, MouseEventArgs e): Open answers popup.

private void objGridVoteNow_MouseLeve(object sender, MouseEventArgs e): Hide the answers popup.

private void BindPollList(string xmlData): Bind data to clsPoll and clsAnsDetails object and make a List collection.

private List<clsPolls>GetData(int pageNumber): Get polls data by page number from poll data collection.

private Border GridBorder( ): Set frame border and make corner round shape.

private Rectangle GridRectangle( ): Set background color for frame.

private void BindFrame(List<clsPolls>PollData): Binding poll data to frame one by one.

private Grid BuildMenu( ): Bind left and right button in bottom of the control.

private Rectangle SelectedCategoryTopRectangle( ): Create rectangle and set background to display the selected category name at top of the control.

private Grid ShowSelectedCategoryTop(int pollCount): Shows the selected category name with poll count at top of control.

private Grid VoteButton(int PollID, List<clsAnsDetails>anslist, int iCount, int iTotalUserVotes): Display the Vote now button.

private Grid UserActivityFrame(int UserID, string UserImagePath, string UserName, int UserActivePollQuestion, int PollAnswersCount, int iCount, int iIsFriend, int iUserStatus): Show user activity on mouse-over of user profile image.

private Grid AnswersFrame(int PollID, List<clsAnsDetails>anslist, int iCount): Bind poll answer data to answer frame.

private Grid GetUserSummary(int PollCreateUserID, string PollCreateUserImagePath, string UserName, int Status): Display the user profile image with user name.

private Grid GetMedia(string PollMediaType, int PollMediaid, int UserID, int PollID, string PollThumbImagePath, string PollFilePath, int IsJMWaterMark): Add media to media frame for each poll.

private Grid AddPollTimer(DateTime PollEndDate, DateTime CurrentDate): Display the time to show remaining time for vote the particular poll.

private Grid GetPollComments(int iCommentCount, int iViewCount, int iTotalUserVotes,int PollID, int UserID): Display the Poll comments, votes and view counts for particular poll with image at the footer of control.

private Grid GetPollRating(int iRating): Show the poll rating.

private void grdShareQuestionMouseLeftButtonDown(object sender, MouseButtonEventArgs e): Open poll sharing options such as sharing at Facebook®, Google®, Digg®, etc.

In addition, the Answeroption class 132 can include poll answers and the ClsAnsDetails class 134 can manage answer options data. Also, according to one embodiment of the invention, the following instructions illustrate an example for retrieving poll data, in XML format, from the server 14:

<Poll>

<PollDetails>

<PollID>114</PollID>
<PollQuestion> Poll question ? </PollQuestion>
<PollImagePath>http://wdedThumbnails/11032009110922.jpg</PollImagePath>
<PollMediaType>I</PollMediaType>
<PollMediaId>504</PollMediaId>
<PollThumbImagePath>1.jpg</PollThumbImagePath>
<PollFilePath>file name</PollFilePath>
<PollViewsCount>34</PollViewsCount>
<TotalUserVotes>0</TotalUserVotes>
<PollCommentsCount>8</PollCommentsCount>
<LastUpdatedDate>2009-11-03T11:14:46.197</LastUpdatedDate>
<UserID>9</UserID>
<UserName>Brian.. H.</UserName>
<UserImagePath>http://www.beta.jabbermonkey.com/1.jpg</UserImagePath>
<UserActivePollQuestion>16</UserActivePollQuestion>
<UserStatus>0</UserStatus>
<PollAnswersCount>40</PollAnswersCount>
<EndDate>Nov 11 2009 12:00AM</EndDate>
<CurrentDate>Nov 6 2009 5:06AM</CurrentDate>
<IsFriend>0</IsFriend>
<IsFeaturedQuestions>1</IsFeaturedQuestions>
<IsFeaturedVideos>1</IsFeaturedVideos>
<IsMostPopular>1</IsMostPopular>
<IsMostRecent>1</IsMostRecent>
<IsJMWaterMark>0</IsJMWaterMark>
<PollAnswer>

<PollAnswerDetails>

<AnswerID>356</AnswerID>
<AnswerText>Yes</AnswerText>
<AnswerFilePath>file path here</AnswerFilePath>
<AnswerMediaType>I</AnswerMediaType>
<AnswerThumbNailPath>1.jpg</AnswerThumbNailPath>

</PollAnswerDetails>
<PollAnswerDetails>

<AnswerID>357</AnswerID>
<AnswerText>No</AnswerText>
<AnswerFilePath>http://gidgetgormley.com/brien.jpg</AnswerFilePath>
<AnswerMediaType>I</AnswerMediaType>
<AnswerThumbNailPath>2.jpg</AnswerThumbNailPath>

</PollAnswerDetails>
<PollAnswerDetails>

<AnswerID>358</AnswerID>
<AnswerText>Unsure (comment)</AnswerText>
<AnswerThumbNailPath>t.png</AnswerThumbNailPath>

</PollAnswerDetails>

</PollAnswer>

</PollDetails>
<ScrollView>

<IsScrollView>1</IsScrollView>

</ScrollView>

</Poll>

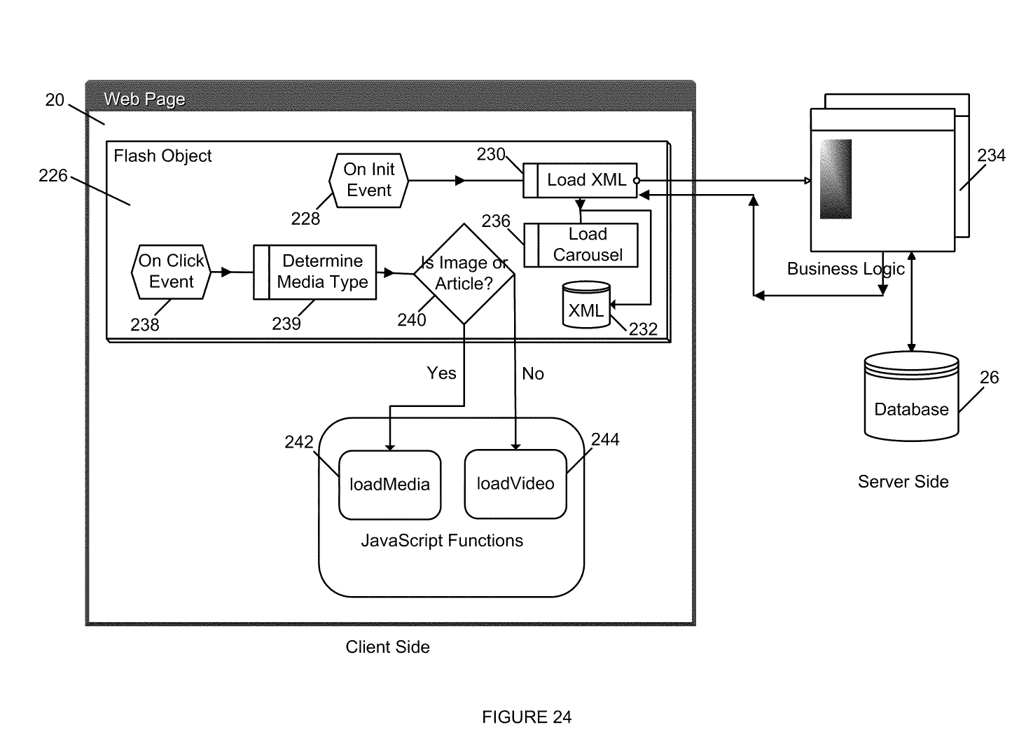

FIG. 24 is an illustrative view of processes of the application 10, according to one embodiment. As shown in FIG. 24, the web page 20 can include one or more flash objects 226, such as flash objects representing the poll frames 28 and the interactive media content 30. Upon initial loading 228 of the flash object 226, a load XML process 230 can be executed which retrieves XML files 232 from the server database 26 (e.g., through BusinessObjects 234). A “load Carousel” process 236 can be executed in order to retrieve the Carousel class 122, as described above, from the XML files 232 so that the Carousel class 122 can be executed to display the poll frames 28. Upon a “click event” 238 (i.e., when the user selects the visual media section 54), a process 239 can be executed to determine the media type, such as article, image, or video. If the media type is an article or image, as determined at step 240, a function 242 (e.g., JavaScript® function “loadMedia”) can be called in order to load the article or image, as further described below. If the media type is a video, a function 244 (e.g., JavaScript® function “loadVideo”) can be called in order to load the video, as further described below.

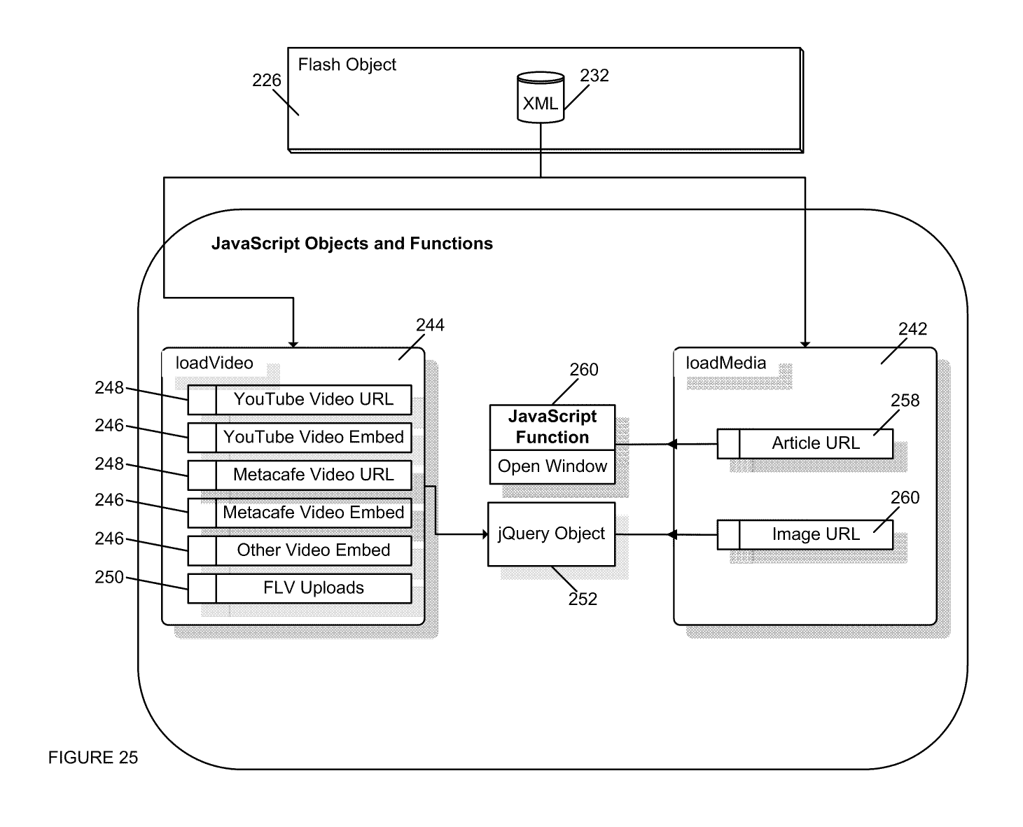

FIG. 25 illustrates objects and functions of the application 10 which can be used to load interactive media content 30, such as articles, videos, and images, on a web page 20. In one embodiment, JavaScript® objects and functions, as interpreted from the XML files 232, can be executed in order to load the interactive media content 30. For example, through the loadVideo function 244, different processes (e.g., if the media content is an embedded video 246, a video URL 248, or an uploaded video 250) can be executed to retrieve a jQuery object 252 in order to load the video. Through the loadMedia function 242, if the media content is an image URL, an image URL process 256 can be executed to retrieve a jQuery object 252 in order to load the image. Also, through the loadMedia function 242, if the media content is an article URL, an article URL process 258 can call another JavaScript® function 260 to open a new web browser window and access the article using the article URL.

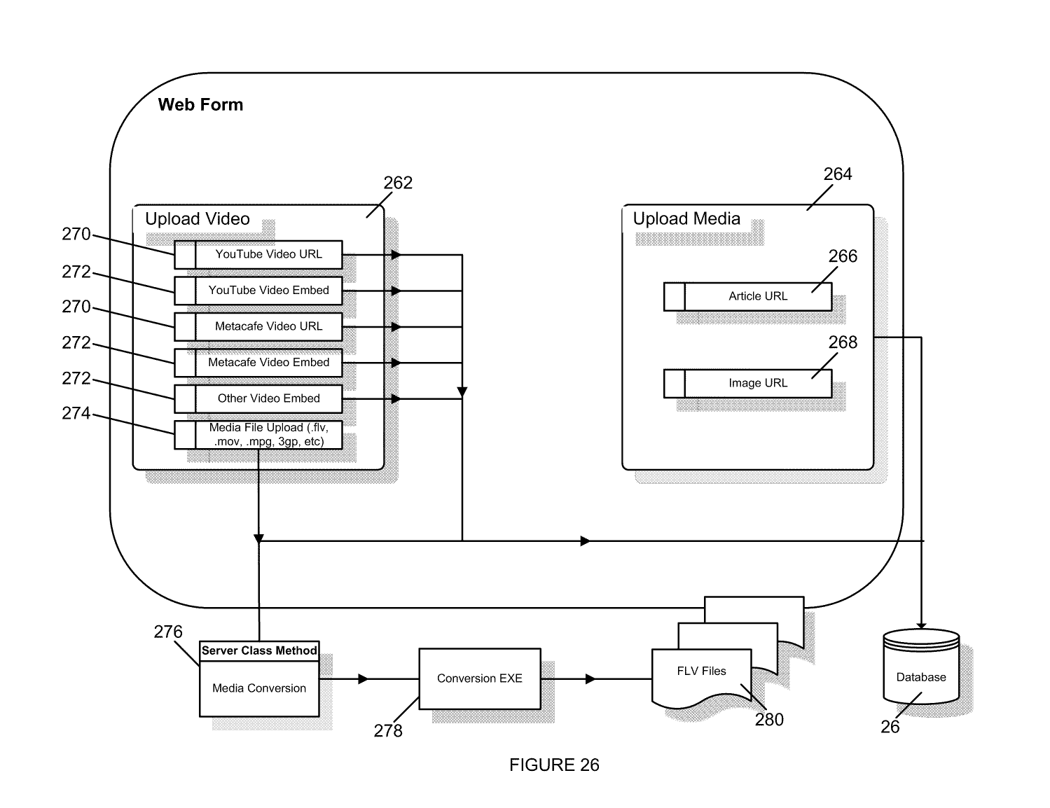

FIG. 26 illustrates processes of the application 10, according to one embodiment, for uploading interactive media content 30 (e.g., during poll creation). Such processes can include a function 262 to upload videos and a function 264 to upload articles or images. If the interactive media content 30 is an article URL or an image URL, the URL data can be stored in a database, such as the server database 26, through an article URL upload process 266 or an image URL upload process 268, respectively. If the media content is a video URL or an embedded video from a separate web site, video information can be stored in the server database 26 through video URL upload processes 270 or embedded video upload processes 272, respectively. If the media content is an uploaded media file (e.g., from the user computer), a media file upload process 274 can be executed, which can include executing a media conversion process 276 using a conversion program 278 in order convert the uploaded video into a Flash Video (FLV) file 280, which can be compatible for use with a flash video player of the web site. In other embodiments, the uploaded videos can be converted to other file types if the web site includes other video players.

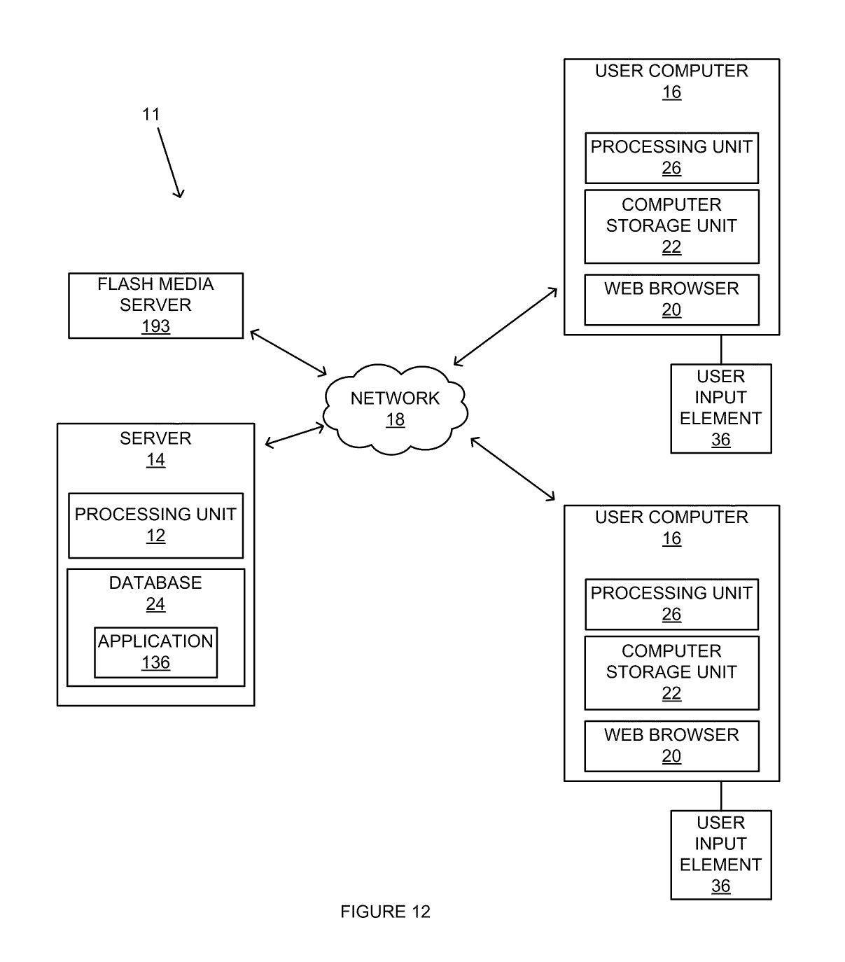

FIG. 12 illustrates the system 11 according to another embodiment of the invention. In some embodiments, a web-based audio, video, and text communication control application 136 can be implemented by the system 11 and incorporated into web pages of the web site. The application 136 can allow users to communicate with each other via live audio, video and/or text through the web site. Communication sessions between users can be accomplished through dynamic communication windows, as described below. The dynamic communication windows can allow users to simultaneously communicate with each other and browse web pages of the web site without having to toggle between different web browsers.

The application 136 can monitor when users are “logged in” to the web site. Users can log into the web site through user computers 16, for example, by visiting the web site via a web browser 22 connected to the server 14 via the network 18. Once logged in (i.e., if the users have provided log in credentials which match those stored on the server database 26), the users can be connected through the server 14 and the network 18, as shown in FIG. 12. In some embodiments, the users can be registered users of the web site.

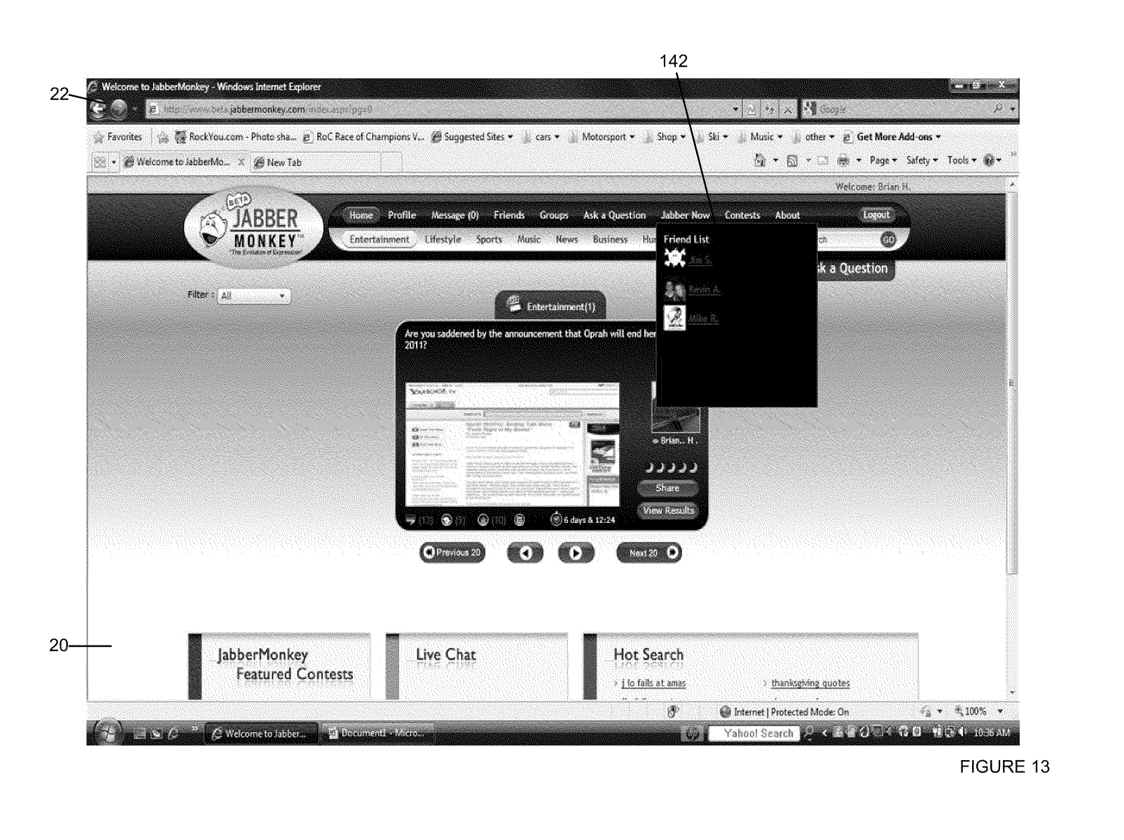

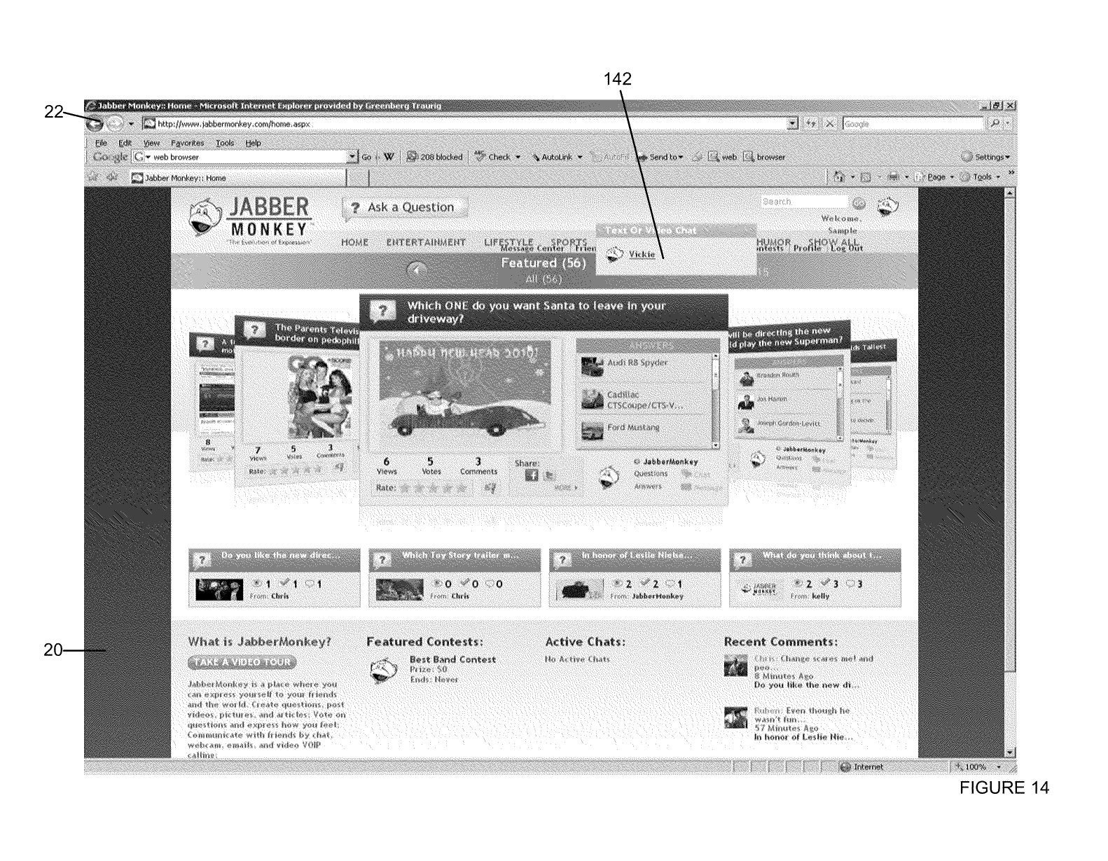

When logged in, the users can view whether other users are logged in to the web site. For example, as shown in FIGS. 13 and 14, a toolbar 138 on the main web page 20 can show a list 142 of logged-in users. Users can be given the option to initiate a communication session with one or more of the other logged-in users from the list 142. Users can choose to initiate a text-only communication session or a text/audio/video communication session, as described below.

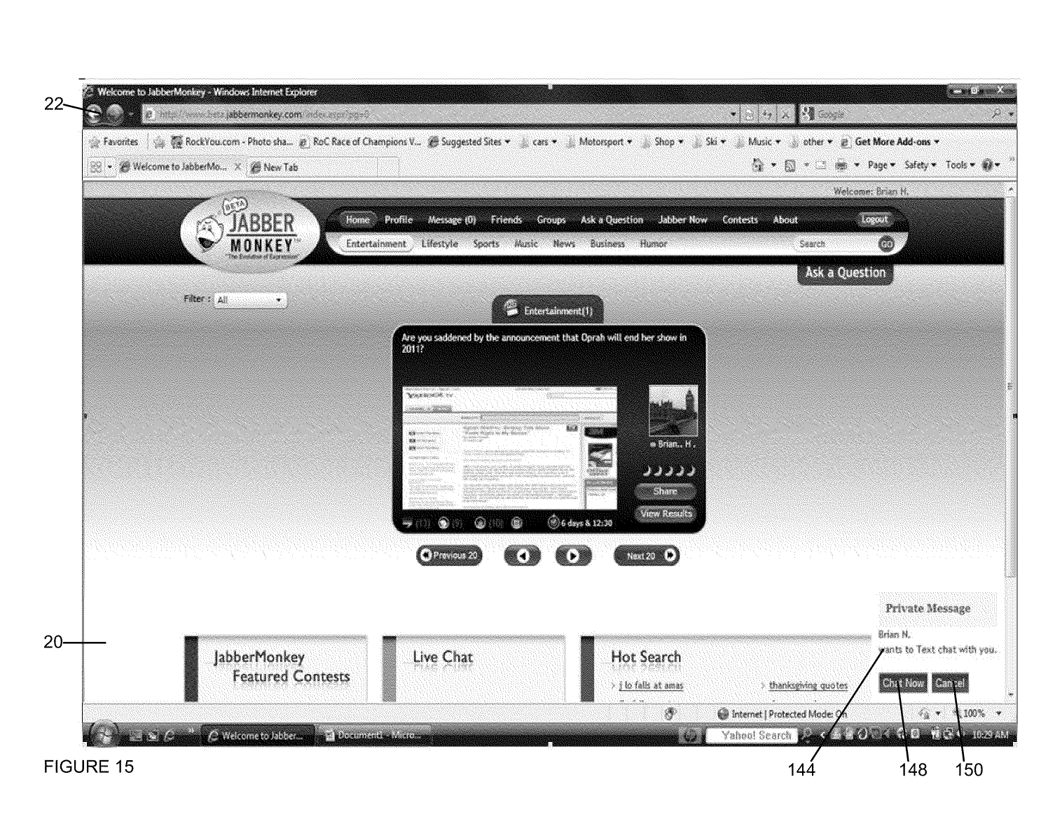

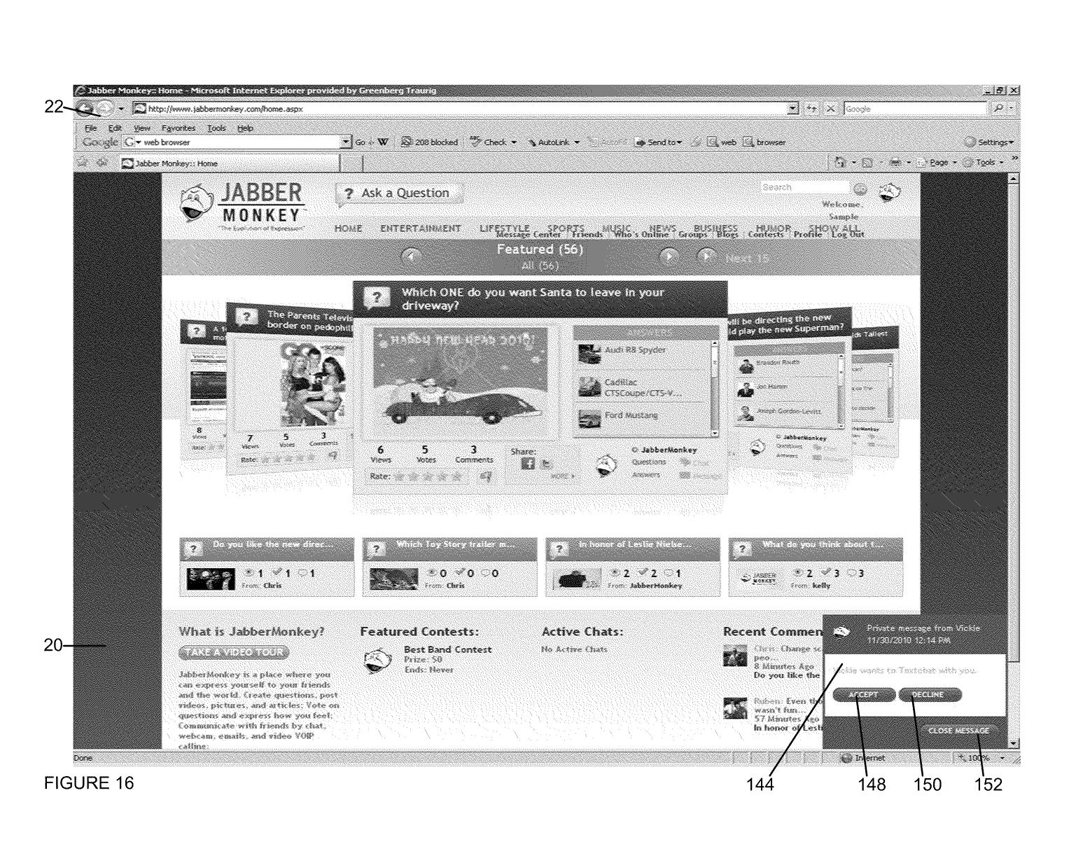

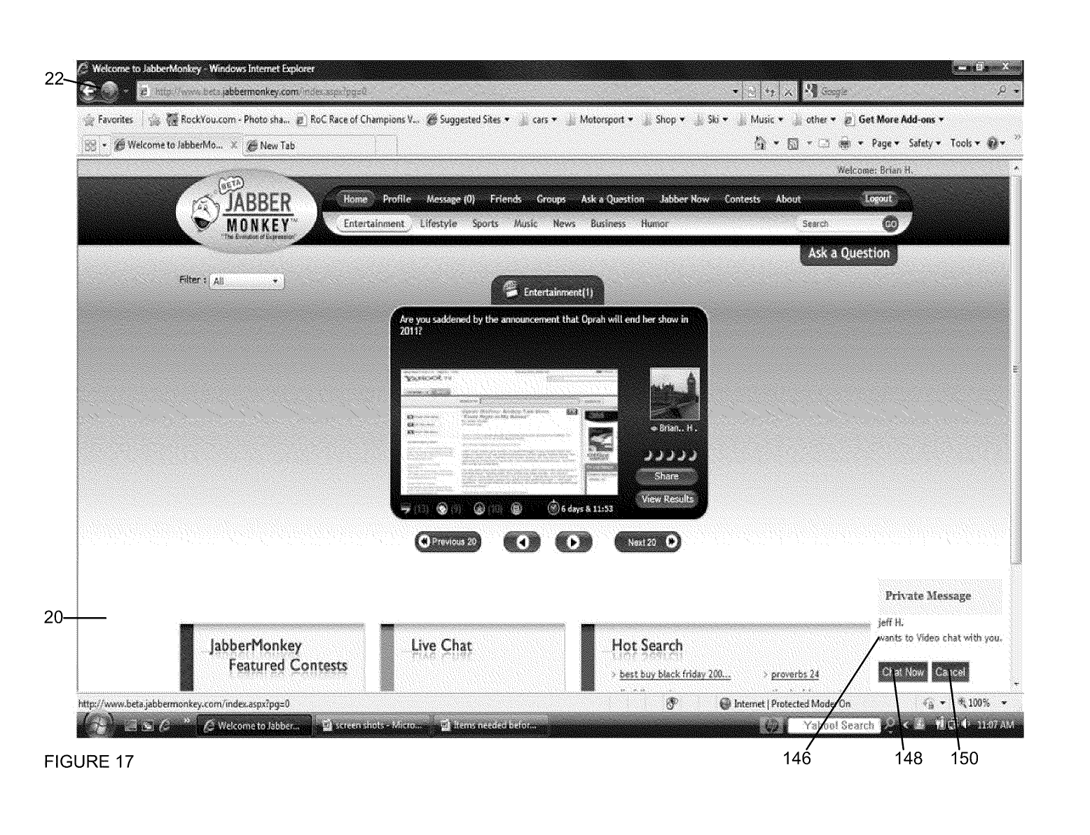

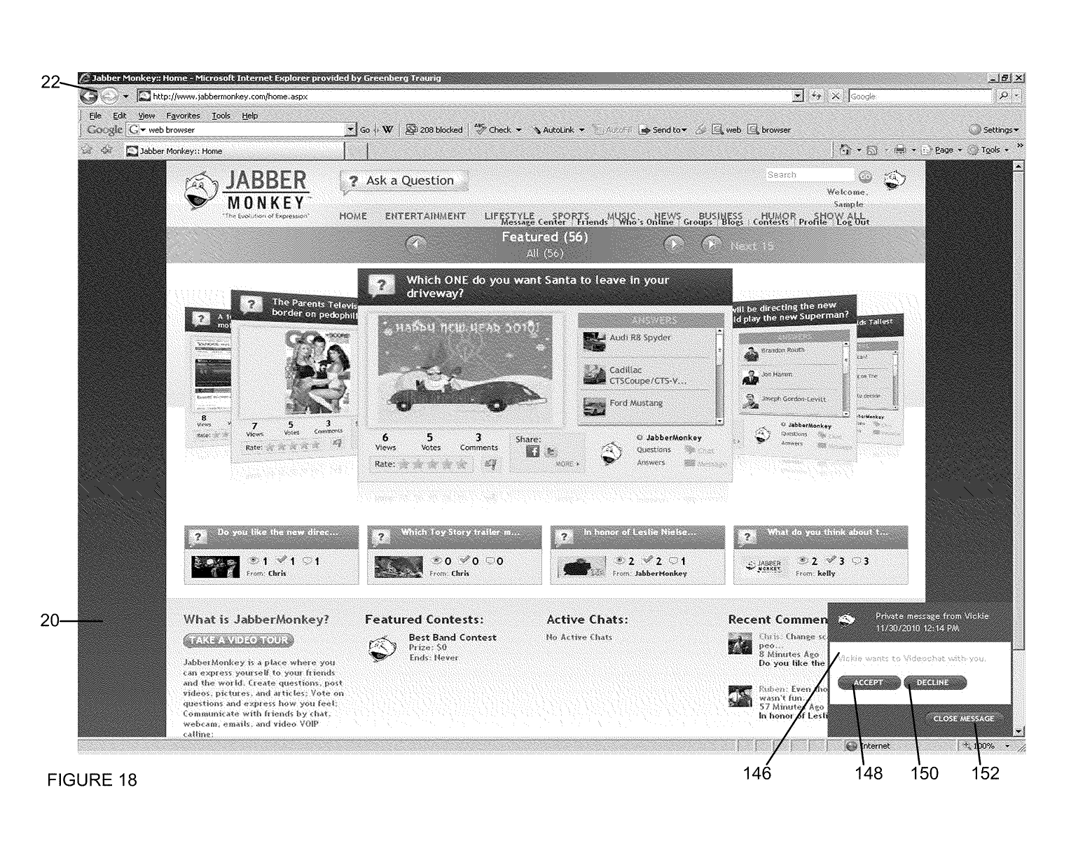

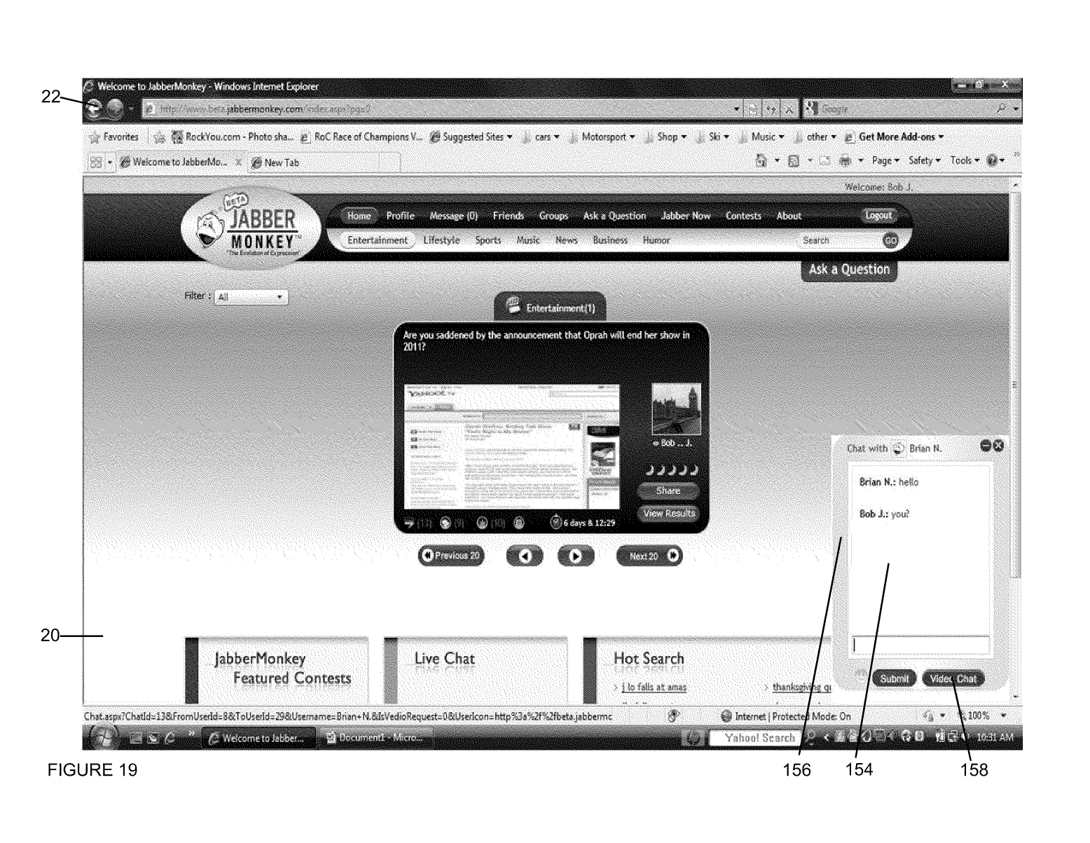

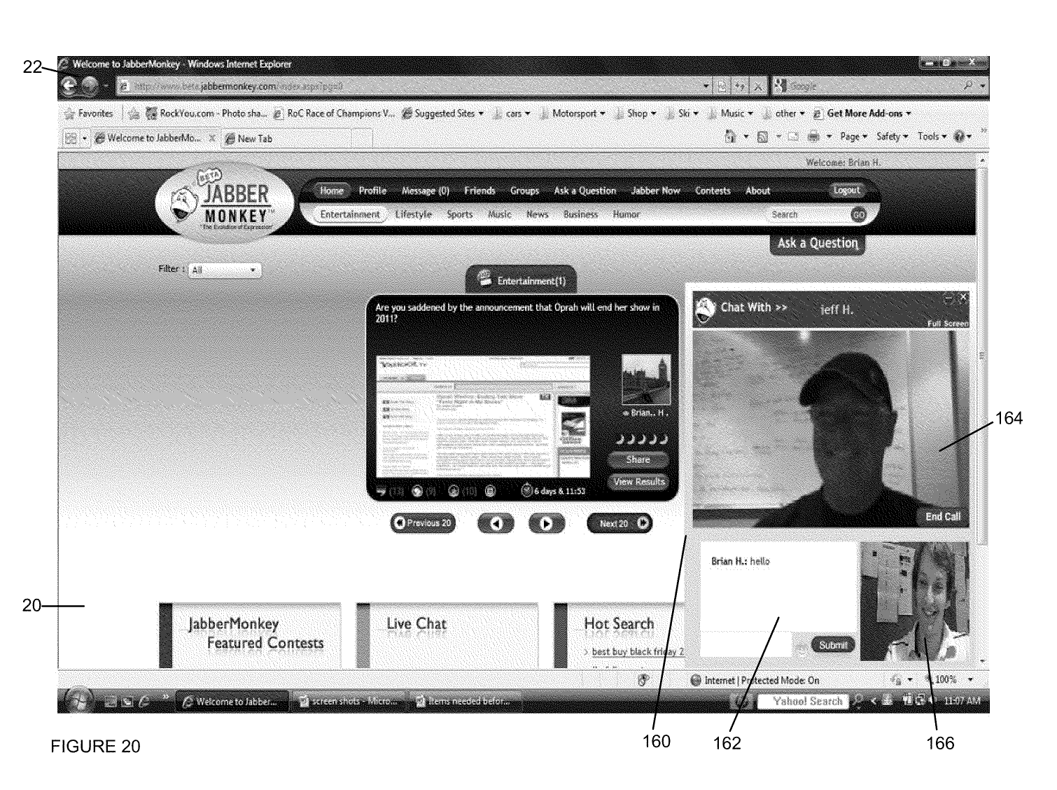

The communication session can be initiated by a first user (e.g., on the first user computer 16) and accepted or denied by a second user (e.g., on the second user computer 16). For example, FIGS. 15 and 16 illustrate a text-only invitation 144 in the second user's web browser 22 and FIGS. 17 and 18 illustrate a text/audio/video invitation 146 in the second user's web browser 22. As shown in FIGS. 15-18, the second user can make a selection to accept the invitation 144/146 (via the “chat now” or “accept” buttons 148) or deny the invitation 144/146 (via the “cancel” or “decline” buttons 150 or the “close message” button 152). In some embodiments, if the communication session is accepted by the second user, a dynamic communication window 154, 160 can be opened in the web browsers 22 of both the first user and the second user, as shown in FIGS. 19 and 20. In other embodiments, the communication window 154, 160 can open automatically in the first user's web browser when they initiate a chat request. The communication window can be a text communication window 154, as shown in FIG. 19, or a text/audio/video communication window 156, as shown in FIG. 20, depending on the type of communication session chosen.

FIG. 19 illustrates a text-only communication window 154. The text-only communication window 154 can allow the two users to send text messages to each other in substantially real-time. The text messages can be displayed in a text window 156. In addition, the text-only communication window can allow either user to alternatively request a text/audio/video communication (e.g., via the “video chat” button 158).

FIG. 20 illustrates the text/audio/video communication window 160. The text/audio/video communication window 160 can allow the two users to communicate via streaming video as well as text messages. The text/audio/video communication window 160 can include a text window 162 as well as a first video window 164 and a second video window 166. The first video window 164 and the second video window 164 can, for example, be flash movie players that display live streaming video from the first user and the second user, respectively (e.g., streaming video and audio from web cameras and microphones connected to the user computers 16). In some embodiments, the application 136 can incorporate flash video (FLV) files and/or small web format (SWF) files communicated through the flash media server 193 for the text/audio/video communication sessions.

Rather than conventional pop-up video and chat windows, the dynamic communication windows 154, 160 can act like an additional toolbar of the web browser 22. As a result, when either user navigates to another web page of the web site or refreshes the current web page within their web browser 22, the communication windows 154, 160 can still be viewable and accessible. More specifically, the communication windows 154, 160 can become a part of any web page on the web site. This can allow users to simultaneously communicate with each other and browse the web site without having to toggle between different web browsers 22 (e.g., between separate web browsers and chat windows, as must be done with conventional chat programs).

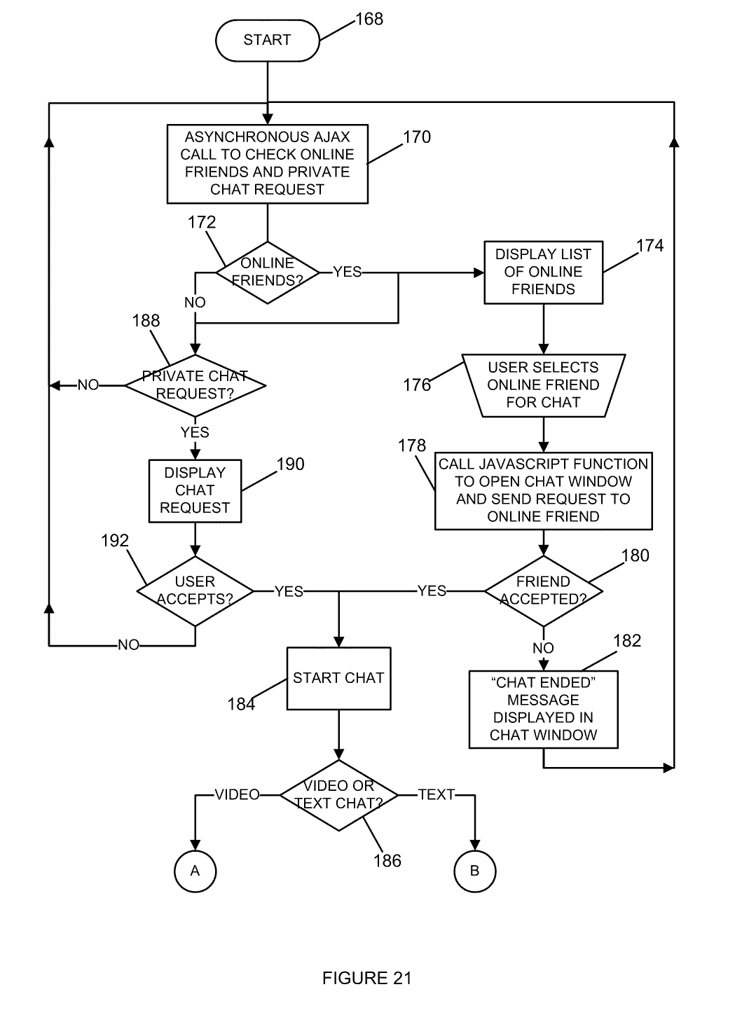

FIGS. 21-23 are flow charts of actions of the communication application 138 according to one embodiment of the invention. As shown in FIG. 21, after the application is started at step 168, (e.g., upon logging in to the web site), the application 138 can check for other logged-in friends or chat requests for the user at step 170. If, at step 172, the application 138 determines that there are online friends, the list of online friends can be displayed for the user at step 174. The user can then select a friend to communicate with at step 176. The application 138, at step 178, can open a communication window 154, 160 in the user's web browser 22 and submit a chat request to the selected online friend. At step 180, the application 138 checks if the friend has accepted or denied the communication request, as described above. If the friend denies the chat request, the application 138 proceeds to step 182 and displays a “chat ended” message in the user's communication window 154, 160, then loops back to step 170. If the friend accepts the chat request, the application 138 proceeds to step 184 to begin the communication session. At step 186, the application 138 can proceed to either text/audio/video communication or text-only communication.

Regardless of whether the application 138 determines that there are online friends at step 172, the application 138 can also determine if a private chat has been requested with the user at step 188. If not, the application 138 can loop back to step 170. If there is a private chat request, the application 138 can display a chat request window in the user's web browser 22 at step 190. If the user denies the request, the application 138 can loop back to step 170. If the user accepts the request, the application 138 can proceed to step 184 and start the communication session.

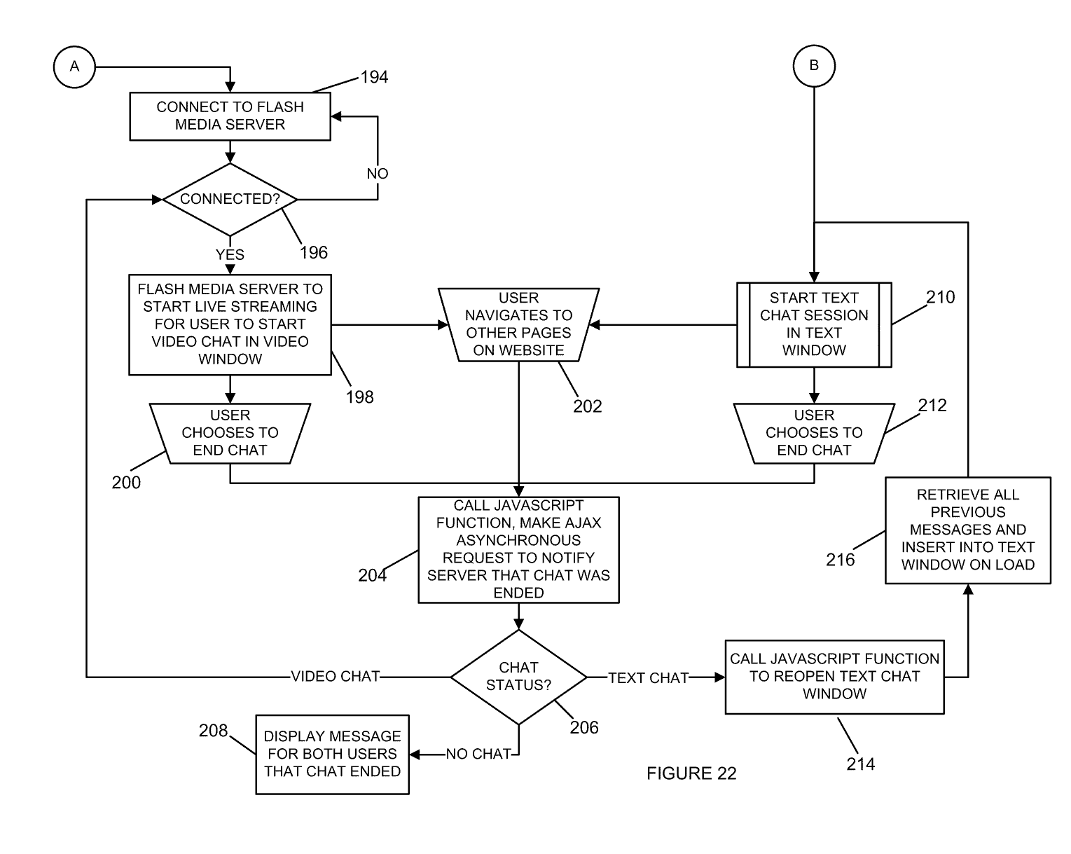

As shown in FIG. 22, if the application 138 proceeds to text/audio/video communication, the application 138 can connect to a flash media server 193 (i.e., through the network 18, as shown in FIG. 12) at step 194. The application 138 can continuously check at step 196 until a connection has been made with the flash media server 193. If the flash media server 193 has been connected, the application 138 can proceed to step 198, where the flash media server 193 provides live streaming video from both user computers 16. The streaming video from both user computers 16 is displayed in the text/audio/video communication windows 160 on both users' web browsers 22. If, at any time one of the users either chooses to end the chat (at step 200) or navigates to another web page (at step 202), the application 138 can notify the server 14 that the chat was interrupted at step 204. The application 138 then determines the status of the communication session at step 206. If the video chat should be continued (e.g., if one of the users simply navigated to another web page), the application 138 proceeds back to step 196. If the video chat should be ended (e.g., if it was requested by one of the users), the application 138 proceeds to step 208 and displays a “chat ended” message in both users' communication windows 160.

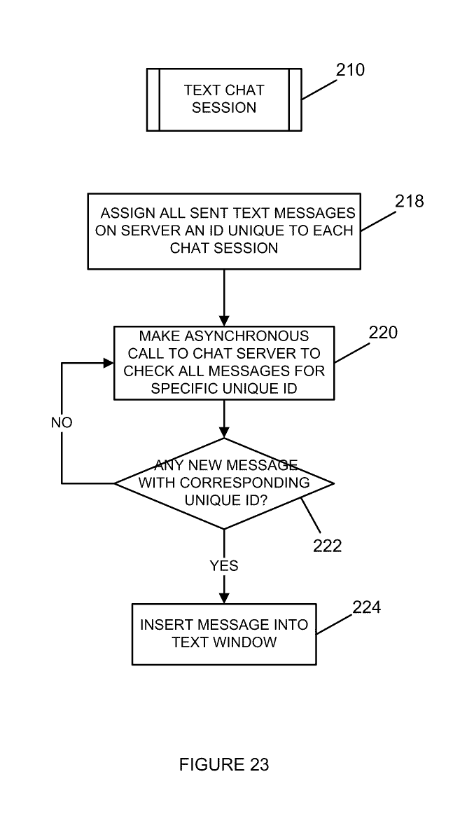

If the application 138 proceeds to text-only communication, the application 138 can start a text session at step 210 (further explained in the flow chart of FIG. 23). If, at any time one of the users either chooses to end the chat (at step 212) or navigates to another web page (at step 202), the application 138 can notify the server 14 that the chat was interrupted at step 204. The application 138 then determines the status of the communication session at step 206. If the text chat should be continued (e.g., if one of the users simply navigated to another web page), the application 138 proceeds to step 214 and ensures the text communication windows 154 in the users' web browsers 22 are open. For example, if one of the users is on another web page, the application 138 will reopen the text communication window 154 over the web page. The application 138 then proceeds to step 216 to ensure all previous messages are displayed in both users' text communication windows 154, and loops back to step 210. If, at step 206, the text chat should be ended (e.g., if it was requested by one of the users), the application proceeds to step 208 and displays a “chat ended” message in both users' text communication windows 154.

FIG. 23 illustrates more detail of the text communication session step (i.e., step 210 in FIG. 22). The application 138 can automatically assign each text message sent to the server 14 (i.e., each text message sent by a user) an identification tag that is unique to the respective chat session at step 218. The application 138 then continues to check, at steps 220 and 222, for any new messages on the server 14 that contain the unique ID specific to the chat session. If, at step 222, the application 138 determines a new message is available for the specific chat session, the application 138 can display the new message in the appropriate user's text communication windows 154 at step 224. In some embodiments, this operation can also be provided for the text/audio/video communication session, where the text messages are displayed in the user's text window 162 (as shown in FIG. 20).

For example, some conventional web site text chat applications use an iFrame method for displaying the entire web site. More specifically, the web site includes one main page continuously displayed and other “web pages” are opened as frame elements of the main page. As a result, the method to get text from one user to another involves loading a new iframe (e.g., a text chat window) on the main web page. Then, that iframe's JavaScript® functions can make HTTP requests over a persistent connection that does not return until the server has data for the client. The request gets reestablished if it is interrupted or times out. Therefore, using this method, chat windows stay on the main page while user navigates to different frames of the web site. Because users do not leave the main page while navigating to different areas of website using the iFrame method, the communication window can constantly stay open.

The application 136, according to some embodiments of the invention, uses a reconnect method, as described above with respect to FIG. 22, in order to continue communication sessions when users navigate away from a main web page. Therefore, the application 136 does not execute communication sessions residing in an iFrame over a main web page. Rather, when a user navigates to a new web page, the previous web page sends a session variable to the server 14 so that the new web page reconnects the communication session. Text messages can be temporarily stored in the server database 26 (or another SQL database of the server 14) as they are communicated between users, while the video and audio can be live streaming through the flash media servers 193 (and not stored in the server database 26). The session variable indicating navigation to a new web page can allow the new web page to retrieve the communication session details from the server database 26 and/or can reconnects the users to the live streaming vide and audio for text/audio/video communication sessions.

The communication application 136 can be incorporated into the web site via the server 14 without requiring installation of additional software on the user computers 16. In addition, in some embodiments, the application 136 can be incorporated into other web-based applications, web sites, or stand-alone computing devices (e.g., single computing devices including the elements of the server 14 and the user computer 16) for web-based communication between users. The application 136 can operate with web browsers 22 such as Internet Explorer® 7.0, Internet Explorer® 8.0, Mozilla® Firefox® 2.0+, Google Chrome™, Safari® 1.2.1+, Netscape® 7.1+, and Opera® 9+. In some embodiments, the application 138 can be adapted for one or more of the following: Microsoft® Visual Studio .Net, Adobe® Media Server, Adobe Flash®; Asp.Net, C# .Net, Jquery, AJAX, XML, HTML, ActionScript®, JavaScript®, and other programming languages and tools. The following chart illustrates example methods for a management class which can bridge user input from the user computers 16 with communication session data stored in the server database 26.

| | Input | OutPut | | |
|---|---|---|---|---|
| Method Name | Parameter | Type | Result | Remark |
| GetChatDetailsBy | UserId | List(Object) | Retreives a list of all online | |
| UserId | | | friends and chat requests. | |
| UpdateChatDetail | FromUserId,ToUserId | BindingList | Retreives new messages and | |
| MessageStatus | | <Object> | updates the message status as | |
| | | | ‘received’ if recieved | |
| GetChatDetailMessages | FromUserId,ToUserId | BindingList | Retreives all messages when a | This method is created to |
| | | <Object> | user navigates to a new page | retrieve all the messages |
| | | | | when user navigate to the site |
| | | | | or refresh the page. |
| GetChatStatus | FromUser,ToUserId | String | Retreives a video | This method is used for |
| | | | communciation session status | getting the chat status during |
| | | | | video communication session |
| InsertChatDetails | (object)ChatDetailDO | String | Inserts the chat detail message | |
| | | | and retreives Unique Id for | |
| | | | that chat session | |
| UpdateChatStatus | FromUserId,ToUserId,ChatStatus | Void | Updates the chat status | This method used when user |
| | | | (Accept/Reject) | accept or reject the chat reqest |
| DeleteChatMessages | FromUserId,ToUserId | Void | Deletes text messages | This method is used when a |
| | | | | user closes the chat session |

In some embodiments, instructions can be developed for the application 136 including a User List class, which can retrieve the list of online users (e.g., make a request to a web page that will return the list of online friends and display chat requests from friends).

The following C#.Net methods can be executed by the application 136, in some embodiments, in relation to the User List class:

getUserlist( ): This method is used to retrieve the online friend list and details corresponding to the users, such as user name, user image path etc.

GetChatRequest( ): This method is used to retrieve chat requests, if any, and return a unique chat ID, friend's ID, and type of request (e.g., text only or text/audio/video).

UpdateChatStatus( ): This method is used to update a chat status depending upon whether the other user accepts or declines the chat invitation.

In addition, the following JavaScript® methods can be executed by the application 136, in some embodiments, in relation to the User List class:

ChatAsycRequest( ): This method is used when user is already logged in to the web site and makes a chat request to a friend; the method calls a method makeRequest(url, onLoadCompleteFunName), as described below, in an fixed interval.

makeRequest(url, onLoadCompleteFunName): This method is used to make an ajax request for a specific aspx page.

CompleteFriendListAndChatRequest( ): This method is used to receive the list of online friends and chat requests.

SetChatDataToDiv( ): This method is used to create a dynamic control which shows a new chat request.

OpenChatAccept( ): This method is used to accept the chat request by using an ajax asynchronous call.

OpenChatReject( ): This method is used to reject the chat request by using an ajax asynchronous call.

OpenChatHeader( ): This method used to call a function CreateDiv( ) at a web page footer to create a dynamic control window.

Also, in some embodiments, instructions can be developed for the application 136 for dynamic chat control (e.g., a Chat class). The dynamic chat control can execute after JavaScript® method ‘Creatediv’ has been called in order to open the communication windows for communication sessions with different online users.

The following C#.Net methods can be executed by the application 136, in some embodiments, in relation to the Chat class:

GetVideo(int FromUserId, int ToUserId, boot b): This method is called when a user wants to start video communication session or accept video session invite. This method creates a dynamic flash movie object and sends different values (FormUserId,ToUserId,ServerUrl etc.) to the flash object, which creates an instance of flash movie object for streaming in the video windows.

GetPrivateMessageOnLoad( ): This method is called when a user navigates to different pages on the web site or refreshes a page to re-load the data for the web page; to preserve the text chat session, the method ‘GetChatDetailMessages’ is used.

GetPrivateMessage( ): This method is used when a user receives any new message using a BL class method ‘UpdateChatDetailMessageStatus’, which in turn identifies the type of request and updates the received messages. For video requests, this method calls the ‘GetVideo’ method.

InsertPrivateMessage(string sChatType): This method is used to insert the text message or video request depending upon the parameters ChatType T(Text Chat) or V(Video Call), where the method ‘InsertChatDetails’ is used to insert the text message in the text windows.

In addition, the following JavaScript® methods can be executed by the application 136, in some embodiments, in relation to the User List class:

enterClick( ): This method calls to set focus on message text window.

SetScrollPosition( ): This method is used to keep a scroll down on click event.

SetPosition( ); This method is called when user accepts the video communication session or sends video communication session request to reposition the text communication window for the video communication window.

ResetPosition( ): This method is called when a user selects to end the communication session.

getVideoStatus( ): This method is used when the video stops publishing due to a user navigating to a different page on the web site or a user refreshing the current web page. In this method, an asynchronous method call is used to check the status of chat in the server database; if it is ‘true’, then its sends message to flash media server to restart the video; if it is ‘False’ then it will send a message to the other user indicating the communication session has ended.

getMovieName(stringToEval): This method returns flash movie object name and calls an ActionScript function stopVideo( ) to stop the video call.

MinimizeChatControl( ): This method is used when a user minimizes the communication window to maintain the minimized position when the user refreshes the web page or navigates to a different web page on the web site by calling an asynchronous call to maintain the position of the communication window.

CreateDiv(Id, href): This creates the communication window and maintains a unique chat window per user implements an iframe to call the communication aspx page.

CloseDiv(Id): This method is called when user selects the close button during the communication session. This method also internally calls the reposition method to reposition any other communication windows and also makes an asynchronous call to delete the data corresponding to the unique ID of the communication session.

In addition, the following functions can be executed by the application 136, in some embodiments, during an audio/video/text communication session (e.g., through Action Script or Flash):

ConnectFMS( ): This function calls when the flash movie is loaded. This function initiates the connection to a Flash Media Server and, if the connection is success, it will access the camera of the user computer and start publishing video.

publishLiveVideo( ): This function is used to publish video from the camera.

EndCall( ): This function will end the video communication session and call a JavaScript function CloseChatControl( ).

PlayLive( ): This function will play a live video/audio stream published from the other user computer.

stopVideo( ): This function is called from Aspx.Net code GetVideoStatus( ), which internally calls GetMovieName( ) (a JavaScript® method) which retrieves the movie file name and checks the status of the communication session; if found false, it calls this stopVideo( ) to stop the video playing and publishing. This process happens when the other user selects “End Call” or logs out of the web site.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A system comprising:
at least one computing device having a processing unit configured to:
provide a graphical user interface displayable at a user computer, the graphical user interface including a first page with at least a first frame including interactive content and a second frame including interactive content;
determine which of the first frame and the second frame is currently selected;
upon selection of the first frame, display substantially an entire portion of the first frame on the first page, enable the interactive content on the first frame, display at least a portion of the second frame on the first page, and disable the interactive content on the second frame; and
upon selection of the second frame, display substantially an entire portion of the second frame on the first page, enable the interactive content on the second frame, display at least a portion of the first frame on the first page, and disable the interactive content on the first frame.

2. The system of claim 1, wherein selection of one of the first frame and the second frame is performed by one of a default action and user input.

3. The system of claim 1, wherein one of the first frame and the second frame is selected by default upon initial display of the first page.

4. The system of claim 1, wherein the interactive content includes at least one of selective virtual buttons, hyperlinks, dropdown menus, video content, and scroll bars.

5. The system of claim 1, wherein the first page includes at least a third frame including interactive content and the processing unit is configured to determine which of the first frame, the second frame, and the third frame is currently selected, and upon selection of the third frame, display substantially an entire portion of the third frame on the first page, enable the interactive content on the third frame, display at least a portion of the first frame and at least a portion of the second frame on the first page, and disable the interactive content on the first frame and the interactive content on the second frame.

6. The system of claim 1, wherein the first page includes up to about twenty frames.

7. The system of claim 1, wherein at least one portion of the interactive media initiates a second page to be displayed when the interactive media is selected by a user.

8. The system of claim 1, and further comprising a server including the computing device, and wherein at least one portion of the interactive media is provided by a user to the server.

9. A computer-implemented method of electronically scrolling through interactive frames, the method comprising:
selecting, using a computing device, data for a plurality of frames from a database;
creating, using the computing device, the plurality of frames based on the data, each of the plurality of frames including interactive content;
assigning, using the computing device, an order of the plurality of frames;
initiating, using the computing device, display of substantially an entire portion of one frame from the plurality of frames in a first frame display position on a page based on the order, the page being displayable to a user on a user computing device;
initiating, using the computing device, display of at least a portion of a next consecutive frame from the plurality of frames in a second frame display position on the page based on the order;
upon detection of a scrolling action by the user from the user computing device,
initiating, using the computing device, display of substantially an entire portion of the next consecutive frame from the plurality of frames in the first frame display position on the page, and
initiating, using the computing device, display of at least a portion of a second next consecutive frame from the plurality of frames in the second frame display position on the page based on the order; and
limiting, using the computing device, user interaction with the interactive content to only the frame in the first frame display position.

10. The method of claim 9, wherein the scrolling action by the user includes one of selecting the next consecutive frame and selecting a virtual scroll button.

11. The method of claim 9, wherein the step of limiting user interaction with the interactive content to only the frame in the first frame display position includes enabling the interactive content in the frame in the first frame display position and disabling the interactive content in the rest of the plurality of frames.

12. The method of claim 9, wherein the interactive content includes at least one of selective virtual buttons, hyperlinks, dropdown menus, video content, and scroll bars.

13. The method of claim 9, and further comprising incrementing a counter, using the computing device, each time a specific frame is displayed in the first frame display position.

14. The method of claim 9, wherein the order of the plurality of frames is continuous so that if the one frame is a last frame assigned in the order, the next consecutive frame is a first frame assigned in the order.

15. The method of claim 9, wherein the data for the plurality of frames includes an expiration time for each of the plurality of frames indicating when each of the plurality of frames expires, and further comprising removing, using the computing device, expired frames from the order.

16. A system comprising:
at least one computing device having a processing unit configured to:
provide a first graphical user interface displayable at a first user computer, the first graphical user interface displaying a first page;
initiate a communication between the first user computer and a second user computer through a first communication window displayed over the first page in the first graphical user interface;
determine if the first communication window has been disrupted due to one of navigation from the first page to a second page on the first graphical user interface and completion of the communication;
if the first communication window has been disrupted due to navigation from the first page to a second page, display the first communication window over the second page and retrieve communication data from a database;
if the first communication window has been disrupted due to completion of the communication, provide an indication to one of the first user computer and the second user computer that the communication has ended.

17. The system of claim 16, wherein the communication includes at least one of text communication and video communication.

18. The system of claim 17, and further comprising the processing unit configured to store text from the text communication as the communication data in the database, wherein the retrieved communication data from a database is displayed in the first communication window when it is displayed over the second page.

19. The system of claim 17, and further comprising the processing unit configured to connect with a server for streaming video between the first user computer and the second user computer during the video communication.

20. The system of claim 19, wherein a connection between the processing unit and the server is disrupted when the first communication window has been disrupted; and further comprising the processing unit configured to reconnect with the server when the first communication window is displayed over the second page.
